(19) United States
(12) Patent Application Publication
(10) Pub. No.: US 2005/0238063 A1
(43) Pub. Date: Oct. 27, 2005

(54) Line connection changing method and device

(76) Inventors: Kenya Takuwa, Yokohama (JP); Hiroshi Ikuta, Yokohama (JP)

Correspondence Address: KATTEN MUCHIN ROSENMAN LLP, 575 MADISON AVENUE, NEW YORK, NY, 10022-2585, US

(21) Appl. No.: 11/158,739

(22) Filed: Jun. 22, 2005

Related U.S. Application Data
(63) Continuation of application No. PCT/JP03/06079, filed on May 15, 2003.

(51) Int. Cl. H04J 3/14

(52) U.S. Cl. 370/538

(57) ABSTRACT

In a method and device performing a change of a line type without saving a service line to a protection line in service at a line level when a unit in service is updated in a transmission device or the like composing a SONET network supporting various types of line connections, when it is analyzed that a control command is requesting a type change of an active line, a change request line in addition to the active line is redundantly managed, and a redundant setting of a line is performed based on line connection setting information of the change request line, and a switchover of the active line to the change request line is performed depending on whether connection destinations of both lines are different or same.

### BACKGROUND OF THE INVENTION

1. Field of the Invention

The present invention relates to a line connection changing method and device, and in particular to a method and device for changing various types of line (circuit) connections for different transmission systems in transmission devices or apparatuses connected to a SONET network or the like.

2. Description of the Related Art

A SONET network or the like supports various types of line connections in view of not only services for transmission systems but also services for subscriber/data systems.

FIG. 18 shows a general arrangement of the SONET network, where four transmission devices NE1-NE4 are connected in a ring form, in which the transmission device NE1 is connected to an STS1 (50M signal of SONET standard) network, and the transmission devices NE3 and NE4 are respectively connected to a DS1 (1.5M signal of SONET standard) network.

In this arrangement, between the transmission devices, and between the transmission device NE1 and the STS network an STS line L2 (optical fiber) shown by a thick line is connected. Each of the transmission lines NE3, NE4 is connected to the DS1 network with a DS1 line L1 (electric line) shown by a thin line.

FIG. 19 shows an arrangement each of the transmission devices NE1-NE4 shown in FIG. 18. In this arrangement, each transmission device is composed of an input/output portion 1, a firmware portion 2 and a hardware portion 3, which respectively have an arrangement and a function as follows:

(1) Input/Output Portion 1:

The input/output portion is composed of an input portion connected to a keyboard and an output portion connected to a CRT device.

The input/output portion has a CUI with an operator, and inputs/outputs a control command for each transmission device.

(2) Firmware Portion 2:

\mathring{1} Command Control Application Portion 21

The command control application portion 21 receives and analyzes the control command inputted from the input/output portion 1.

The command control application portion 21 generates line connection setting information based on an analysis result of the control command to be provided to a hardware portion 3, thereby performing a line setting.

The command control application portion 21 returns a result of execution to the input/output portion 1 in response to the control command.

\mathring{2} Database Portion 22

The database portion 22 stores the line connection setting information for the hardware portion 3 as a backup.

The database portion 22 stores a setting of each hardware within the transmission device and other operation information.

When the hardware setting and the operation information are lost due to a power interruption or the like, the application portion 21 reads the line connection setting information and the operation information stored in this database portion to be set in each hardware, thereby recovering the hardware setting and the operation information.

(3) Hardware Portion 3:

The hardware portion 3 mounts thereon various units for a VT1 (1.5M signal of SONET standard obtained by adding an overhead to a DS1 signal) line and an STS1 line (VT1 line multiplexed into 28 lines), performs a line connection, and has main units required for a line connection indicated in the following description.

\mathring{1} DS1 Unit 31

The DS1 unit 31 maps a DS1 line signal transmitted from an opposing transmission device into a VT mapping STS1 to be outputted.

Reversely, the DS1 unit 31 maps the VT mapping STS1 line signal inputted to the DS1 line signal to be transmitted to the opposing transmission device.

The DS1 unit 31 has 28 DS1 line interface ports.

\mathring{2} STS Switch Fabric (STS-SF) 32

The STS switch fabric 32 performs a line setting by receiving the line connection setting information from the firmware portion 2.

\mathring{3} VT Switch Fabric (VT-SF) 33

The VT switch fabric 33 maps a VT mapping STS line signal inputted from the STS switch fabric 32 into a VT1 line signal to perform a connection of each VT1 line.

The VT switch fabric 33 maps each VT1 line to the STS1 line at an output time to be outputted to the STS switch fabric 32.

\mathring{3} OCn Unit 34

The OCn unit 34 inputs/outputs the STS1 line on an OCn line to the opposing transmission device side from the STS switch fabric 32. It is to be noted that in the following description, an OC3 unit will be described, taken as an example where n=3.

Furthermore, each transmission device is provided with slots for mounting therein various interface units such as a DS1, an OC3, and a VT switch fabric and slots for mounting therein units essential for a system such as an STS switch fabric 32 and a CPU.

A user can mount a required number of interface units in an arbitrary slot. Also, a user can freely perform a line setting in which a required number of lines are combined (mixed) as appropriate for the mounted slot.

FIGS. 20A and 20B show a transmission device performing a connection from the DS1 network to the STS1 network with the STS1 line. FIG. 20A shows the hardware portion 3 within the transmission device, and FIG. 20B shows the database portion 22.

A setting example of the STS1 line shown in FIGS. 20A and 20B will now be described.

Firstly, this line setting example deals with an example of the line setting performed with an STS1 line type from a DS1 unit 31_1 (hereinafter, occasionally represented by a reference numeral “31”) mounted in a slot SLT1, which is the first slot, to an STS-ch (channel) 1 of the first port OC3-port1 of the OC3 unit 34 mounted in a slot SLT3, which is the third slot.

As the control command for performing the line setting, the following command form cited from a TL1 command is used.

“ENT-CRS-STS1::1-1-1,3-1-1”

It is to be noted that “ENT” indicates new line setting (enter), and CRS indicates cross-connect.

A line position of a command: l-m-n is as follows:
l: slot (1 to the maximum slot number=20)
m: port (1 to the maximum port number of a network side of the DS1/OC3 unit mounted in the slot=28)
n: STS-ch (1 to the maximum STS channel number held by the port of the DS1/OC3 unit=48)

In order to set up the STS1 line in this case, a line position in the STS switch fabric 32 to which the DS1 unit 31 is connected is defined as X, a line position in the STS switch fabric 32 to which the OC3 unit 34 is connected is defined as Y, and a line position of a new unit 35 mounted in a slot SLT9 is defined as Z as shown in the database portion 22 of FIG. 20B.

Accordingly, if the line connection setting information by the above-mentioned control command is applied to the example of FIGS. 20A and 20B, X=1-1-1 and Y=3-1-1 since an STS-ch1 of the STS switch fabric 32 within the first port (see DS1-port1 of FIG. 22A) on the network side of the DS1 unit 31_1 mounted in the first slot SLT1 is connected to the STS-ch1 within the first port (see OC3-port of FIG. 22B) on the network side of the OC3 unit 34 mounted in the third slot SLT3.

A detailed description of the line connection setting information is indicated in FIGS. 21A and 21B and the following figures. FIGS. 21A and 21B show a case where the STS line setting state shown in FIGS. 20A and 20B has changed to the VT1 line setting.

Namely, a case where a line setting is performed by a VT1 line type to the STS1-ch1 in the first port OC3-port1 of the OC3 unit 34_1 (hereinafter, occasionally represented by a reference numeral “34”) mounted in the slot SLT3 from the STS1-ch1 of the DS1 unit 31_1 mounted in the slot SLT1. The mounting state of the DS1 unit 31 and the OC3 unit 34 is the same as the example shown in FIGS. 20A and 20B.

The example of the control command in this case is as follows:
“ENT-CRS-VT1::1-1-1-1-1,3-1-1-1-1”
“ENT-CRS-VT1::1-2-1-1-1,3-1-1-1-2” (where VT-ch2 is similarly set).
. . .
“ENT-CRS-VT1::1-28-1-1-1,3-1-1-7-4”

In the same way as the example of FIGS. 20A and 20B, the line position l-m-n-vtg-vt of the control command will be described as follows:
l: slot
m: port
n: STS-ch
vtg: VT group (1-7) (VT1 for 4 channels is made a single group)
vt: VT channel (1-4)

The DS1 unit 31, as magnified and shown in FIG. 22A, has a port per DS1 line L, m=28 ports (DS1-port1 to DS1-port28) in the example of FIG. 22A. The DS1 signal inputted to each port is mapped by a mapping portion 310 into assume an STS1 signal for a single channel.

In this example, the STS1 signal is outputted as an STS-ch1 signal, connected to the STS-ch1 within n=48 channels (STS-ch1 to ch48) assigned to the single DS1 unit 31 of the STS1 switch fabric 32, and forms an STS1 path (STS-path2) to be transmitted to the VT switch fabric 33.

In the VT switch fabric 33, as shown in FIG. 21A, the STS-path2 is connected to e.g. a VT-port2 on the input side, and is outputted from the VT-port2 on the output side. In this case, “VT-port1-” has nothing to do with the port “m” in the above-mentioned line position description l-m-n-vgt-nt, and which VT-port the STS-path2 is connected to is determined by the retrieval of the software of the application portion 21.

It is to be noted that the ports of DS1-port1 to DS1-port28 in the DS1 unit 31, as mentioned above, are further divided into seven VT groups by vtg with the VT1 line position of the control command as “m”, and in each VT group, four channels are further assigned as vt. Accordingly, as shown in FIG. 22A, the VT1 line position vtg-vt=1-1 to 7-4 are assigned to the mapping portion 310.

Also, with the above-mentioned description l-m-n-vtg-vt, the accurate description of the control command assumes 1-“1”-1-1-1, 1-“2”-1-1-1, 1-“3”-1-1-1 . . . 1-“28”-1-1-1. Since 28 channels of VT1 of the DS1-port1 to DS1-port28 are all accommodated in a single line of the STS1, ¢1-1-1” is actually enough for the line setting of the STS1 line, so that it is arranged that the port description is fixed to m=“1”.

On the other hand, in the OC3 unit 34 mounted in the slot SLT3, as shown in FIG. 22B, 48 STS1 channels are assigned for the single OC3 unit 34, as is the case of the DS1 unit 31. A line setting is performed so that the STS1-ch1, one of the 48 channels may output the signal of the STS1-path2 from the VT switch fabric 33 to the OC3 unit 34.

The signal of the STS1-ch1 is mapped by a mapping portion 340a for three channels together with the STS-ch2 and STS-ch3 to be outputted from the port OC3-port1. Similarly by a mapping portion 340b, the STS-ch4-STS-ch6 are mapped to be outputted from the port OC3-port2.

Thus, the line connection setting information by the above-mentioned control command corresponds to X=1-1-1, Y=3-1-1 when it is applied to the example of FIGS. 21A and 21B.

The contents of the line connection setting information stored in the database portion 22 for such a control command are indicated in FIGS. 23, 24, 25A, 25B, 26A and 26B.

FIG. 23 shows a database area 220 for storing STS line setting for the above-mentioned description l-m-n. In this example, the DS1 unit 31_1 mounted in the slot SLT1 assigns the STS-ch1 and the STS-ch4 of the STS switch fabric 32 to the STS1 line. In the case of a DS1 unit 31_2 mounted in the slot SLT2, it is indicated that in the STS-ch1 of the STS switch fabric 32, the line setting for the STS3C is performed.

Also, it is indicated that at a slot SLT/MAX (corresponding to the last=20th slot of the maximum number of mounting slots), the STS-ch1 of the STS switch fabric 32 performs the line setting at VT1

It is supposed that areas for the STS1 number=(maximum slot number)×(maximum STS channel number which a single slot can accommodate) accommodatable in a system are prepared in the database area 220.

Also, when a user performs a line setting for a certain line position X, a line type is supposed to be set for the database area 220 corresponding to the line position X.

It is to be noted that the example of FIG. 23 is for general description apart from the line setting example shown in the above-mentioned FIGS. 20A, 20B, 21A and 21B.

FIG. 24 shows a VT line setting storing database area 221 for the above-mentioned description vtg-vt. The ports in the VT-port1 to VT-port/MAX (see FIGS. 21A and 21B) of the VT switch fabric 33 accommodate the VT1 channels VT-ch to VT-ch28 shown in FIGS. 22A and 22B. In this example, it is indicated that in the channels VT-ch1 to VT-ch4, the VT1 is set, and in the channel VT-ch1 in the VT-port/MAX, VT1 is similarly set.

It is to be noted that areas for VT1 number=(maximum port number held by the VT switch fabric 33)×(maximum VT channel number 28 accommodated per STS1 bandwidth) accommodatable in the system are prepared in the VT line setting storing database area 221.

Also, when the VT1 line is set, as shown in FIG. 23, “VT1” is registered in the database area 220 for storing STS line setting, and the update is also performed to the VT line setting storing database area 221 shown in FIG. 24 at the same time.

Accordingly, it is supposed in the following description that when the database area 220 for storing STS line setting is set to “VT1”, the update is also performed to the VT line setting storing database area 221. Therefore, the description of the VT line setting storing database area 221 will be omitted.

FIG. 25A associates the database area 220 for storing STS line setting shown in FIG. 23 with the above-mentioned line setting example of FIG. 20A.

Namely, the line setting of the STS1 is performed to the channel STS-ch1 of the DS1 unit 31_1 mounted in the slot SLT1, and the line setting of the STS1 is also performed to the channel STS-ch1 of the OC3 unit 34_1 mounted in the slot SLT3. The database portion 22 at this time indicates that the position X=1-1-1 and the position Y=3-1-1 are connected with the STS1 line as shown in FIG. 25B. This is the same as the database portion 22 of FIG. 20B.

It is indicated that the database area 220 for storing the STS line setting shown in FIG. 26A is associated with the line setting example shown in FIG. 21A.

Namely, it is indicated that the line setting of the VT1 is performed to the channel STS-ch1 of the DS1 unit 31_1 mounted in the slot SLT1, and the line setting of the VT1 is performed to the channel STS-ch1 of the OC3 unit 34_1 mounted in the slot SLT3. As shown in FIG. 26B, it is indicated in the database portion 22 that the position X=1-1-1 and the position Y=3-1-1 are connected with the line VT1. This is the same as the database portion 22 of FIG. 21B.

In the above-mentioned database areas 220 and 221, only the line setting is provided and a connection relationship between lines is not indicated. Namely, when a user sets a line for a certain line position X, it is required to set its line connection destination for the database area 220 for storing STS line connection destination setting corresponding to the line position X.

This state is shown in FIG. 27. When it is desired to recognize whether or not a line setting exists between the line positions X-Y, it is found by referring to the database area 222 that a connection setting exists from the line connection source position X=1-1-1 for the line connection destination position Y=3-1-1 (connected from 1-1-1 to 3-1-1). When the line setting is performed and if the connection destination is changed, the database area 222 may be updated at any time.

The STS switch fabric 32 has a line (path line) switch which controls switching of two lines. When lines from two different line positions to the same line are set, the hardware determines the line setting arrangement, and forms an arrangement using the line switch.

The line switch, as shown in FIG. 28, is used at the time of arranging a line redundancy called a UPSR (Uni-Directional Path Switched Ring), and has a function of switching over the line to a side of a protection line L2_2 when a fault occurs in e.g. a working line L2_1. Also, it is known as a switch which can compulsorily actuate a line switch SW by the setting from the firmware portion 2.

FIG. 29 shows such a line switch magnified. The STS switch fabric 32 has the line switch SW for controlling the switching over two lines, i.e. the working line L2_1 and the protection line L2_2. When the line setting is performed from the different line positions to the same line position Y, the hardware portion 3 having received the line connection setting information determines the line setting arrangement to form the line switch SW as shown in FIG. 29.

It is to be noted that when the line switch is compulsorily switched over on the hardware with the software, the switchover at the time of fault mentioned above does not function. Accordingly, a switchover release is required to be performed with the software so that the line compulsorily switched can perform the original switchover upon a fault occurrence.

There is a line connection changing system of a SONET transmission device comprising an HMI controller analyzing a request command from a terminal and requesting the execution to a main controller, a line type instruction table including a plurality of line connection instructing functions, a main controller including a line connection information managing portion which stores line connection information in service presently and controlling the execution of the request from the HMI controller, a service line terminal portion terminating a service line, and a multiplexer/demultiplexer multiplexing/demultiplexing a signal (see e.g. Patent document 1).

<Patent document 1>

Japanese Patent Application Laid-open No. 9-36882 (Abstract and FIG. 1)

As mentioned above, in the conventional technology, when the line (STS1 line) shown in FIG. 20A is changed to the line (VT1 line) shown in FIG. 21A, namely when the line type is changed, and if the VT1 line connection is permitted in a state where the STS1 line is connected, the setting information of the VT1 line overwrites the information in the database portion 22, so that the original STS1 line can not be controlled.

Therefore, unless a line setting (ENT) is performed twenty-eight times in the line setting example of FIG. 21A by a procedure of “line connection presently used is once disconnected and a reconnection is then performed” when the type of the line connection is shifted or changed, a line connection can not be changed, so that it has been disadvantageous that during the procedure, a service disconnection is unavoidable.

### SUMMARY OF THE INVENTION

It is accordingly an object of the present invention to realize a line connection changing method and device which \mathring{1} do not require an execution of a plurality of line setting procedures and \mathring{2} in which no service disconnection occurs.

In order to achieve the above-mentioned object, a line connection changing method according to the present invention, as a generic concept, comprises the steps of analyzing a control command inputted to generate line connection setting information; performing a line connection per line type according to the line connection setting information; redundantly managing, when it is analyzed that the control command is requesting a type change of an active line, a change request line in addition to the active line; performing a redundant setting of a line based on line connection setting information of the change request line; and switching over the active line to the change request line corresponding to whether connection destinations of both lines are different or same.

Namely, in the present invention, an inputted control command is analyzed, and when it is analyzed that the control command is requesting a type change of a line in service, the active line and the change request line are redundantly managed.

Based on line connection setting information according to the change request, a redundant setting of a line is performed with the active line, and the active line is switched over to the change request line depending on whether or not the connection destinations of both lines are same or different.

Thus, if data are made redundant so that both of a new and old lines can be controlled, and a line position and a connection site are managed, the control of the old line is enabled. Therefore, it becomes possible to realize a change of a line type by a single control command in a state where no service interruption occurs (in-service).

A generic concept by the above-mentioned present invention can be divided into following four modes [1]-[4]. These will now be described sequentially referring to a flowchart shown in FIG. 1.

[1] In the above-mentioned generic concept, the mode of the present invention may further comprise the step of, when it is analyzed that, after performing the redundant setting, the control command is not requesting a change of a connection destination, switching over the active line to the change request line whose connection destination is the same as that of the active line and whose line type is different from that of the active line.

Namely, as shown in FIG. 1, after the control command is received, whether or not the types of the new and old lines are the same is confirmed referring to database areas 220 and 221 shown in e.g. FIGS. 23, 24, 25A, 25B, 26A and 26B (at step S1). When they are the same, the prior art method can support it (at step S2). When they are different from each other or the old line is not set, it is determined whether or not a line setting in service (X and Y of FIGS. 2A-2D, 20A and 20B, etc) exists referring to e.g. the database 222 shown in FIG. 27 (at step S3).

As a result, when the active line is set, the line connection setting information in service is stored (copied) in e.g. a new table (at step S4). It is to be noted that at step S3, the case where connection sources (e.g. X) are different from each other is not an object of the present invention and can be supported by the prior art method (at step S2).

The line connection setting information requested by the control command is overwritten in e.g. a database portion of a firmware portion, and based on the line connection setting information, the line setting is performed (at step S5).

Thus, after performing the redundant setting, whether or not connection destinations of the line connection setting information of the active line stored in the new table and the line setting information of the change request line stored in the database portion are the same is determined (at step S6). When they are the same, a line switch in e.g. the above-mentioned STS switch fabric is compulsorily switched over with software, so that the line is switched over to the change request line whose connection destination is the same as that of the active line and whose line type is different from that of the active line (at step S7).

In the presence of a line setting in the above-mentioned new table, a release setting of the line is performed (at step S8), and whether or not the connection destinations of the old line and the new line are the same is checked again (at step S9). Only when they are the same in the same way as the above-mentioned step S6, the state of the line switch compulsorily switched over at step S7 is released with the software (at step S10), and the data of the new table are cleared (at step S11).

It is to be noted that the control command in this case includes an existing connection source, an existing connection destination and a new line type.

Also, the line type is an STS line and a VT line described in the above prior art example, a TL1 command can be used as the control command.

[2] In the above-mentioned generic concept, the mode of the present invention may further comprise the step of, when it is analyzed that, after performing the redundant setting, the control command is requesting a change of a connection destination, switching over the active line to the change request line by releasing a line setting of the active line.

Namely, the case of this mode passes through a common procedure with that of the above-mentioned mode [1] from step S1 to step S5. However, it is indicated that the connection destinations of the old line and the new line are different from each other at step S6, and step S7 is skipped since a compulsory switchover of the line switch is not required. The setting of the active line is released based on the line connection setting information set in the new table at step S8. When it is determined that the connection destinations of the old line and the new line are different from each other at step S9, the compulsory switchover release of the line switch at step S10 is not required. Therefore, step S10 is skipped and data of the new table are cleared at step S11.

It is to be noted that the control command of this case includes an existing connection source, an existing connection destination, a new connection source and a new connection destination of a new line type.

[3] In the above-mentioned generic concept, the mode of the present invention may further comprise the step of, when it is analyzed that the control command is requesting broadcasting by a plurality of lines whose types are different from that of the active line, switching over, after performing the redundant setting, a part of the active lines for which a change of a connection destination is not requested from the active lines to a channel area of a part of lines whose connection destinations are the same as that of the active line and whose types are different from that of the active line.

Namely, the mode [3] basically executes the same procedure as the above-mentioned mode [1] in FIG. 1. However, the mode [3] is different from the mode [1] in that the line connection setting information required by the control command stored in the database portion is the line connection setting information for broadcasting including different connection destinations of types different from that of the active line stored in the new table, and that the line setting of the broadcast is performed correspondingly.

Also, there are cases where the connection destinations of old line and new line are the same and different at step S6. Namely, when the broadcast is made through the line of the type to be changed, some lines have the same connection destinations as that of the old line, and other lines have different connection destinations from that of the old line. When the connection destinations are the same, the line switch is compulsorily performed (at step S7). However, when the connection destinations are different from each other, the step S7 is skipped and the process proceeds to step S8 to perform the release setting of the active line in the new table.

Similarly, there are a case where the connection destinations of the old line and the new line are the same and a case where the connection destinations are different from each other at step S9. Therefore, there are a case where step S10 is skipped and a case where the step S10 is passed through. Hereafter, the data of the new table are cleared (at step S11).

The control command in this case includes an existing connection source, an existing connection destination, a new line type, a channel area of a new line type whose connection destination is the same as that of the existing connection destination and a channel area of a new connection destination of a new line type used for broadcasting except the existing connection destination.

[4] In the above-mentioned generic concept, the mode of the present invention comprises the steps of analyzing a control command inputted to generate line connection setting information; performing a line connection per line type according to the line connection setting information; and setting, when it is analyzed that the control command is requesting a setting of a line whose new setting is desired per bandwidth and by a desired type, the line by the type and per bandwidth.

In this mode, it is not assumed that the old line exists. Therefore, in the flowchart of FIG. 1, as a result of the confirmation of the type of new and old lines at step S2, the process proceeds to step S3 since the old line does not exist, and step S4 is skipped since no line setting in service exists at step S3, so that the process proceeds to step S5.

At step S5, the line setting is performed per bandwidth by a desired line type according to the change request.

Hereafter, in this mode, steps S6-S11 are skipped and a command response is transmitted.

It is to be noted that the control command in this case includes a new connection source, a new connection destination, a bandwidth to be set, a new line type, and the like.

A device, as a generic concept realizing the line connection changing method according to the above-mentioned present invention comprises: an input/output portion which can input/output a control command; a firmware portion which analyzes the control command to generate line connection setting information; and a hardware portion which performs a line connection per line type according to the line connection setting information; the firmware portion redundantly managing, when it is analyzed that the control command is requesting a type change of an active line, a change request line in addition to the active line, and performing a redundant setting of a line by providing line connection setting information of the change request line to the hardware portion, and the hardware portion switching over the active line to the change request line corresponding to whether connection destinations of both lines are different or same.

Namely, a firmware portion analyzes the control command inputted from an input/output portion. As a result, when it is realized that the control command is requesting a type change of an active line, the active line and a change request line are redundantly managed. A redundant setting of a line is performed by providing line connection setting information of the change request line in this case to the hardware portion. Furthermore, the hardware portion switches over the active line to the change request line corresponding to whether connection destinations of both lines are different or same.

[5] In the above-mentioned generic concept device, in the mode of the present invention corresponding to the above-mentioned mode [1], the above-mentioned firmware portion may be composed of an application portion and a database portion, and the application portion may store line connection setting information of the active line stored in the database portion in a new table, may store the line connection setting information of the change request line in the database portion to perform a redundant management of line connection setting information, and may switch over the active line to the change request line whose connection destination is the same as that of the active line and whose line type is different from that of the active line by controlling a compulsory switchover of a line switch of the hardware portion when it is analyzed that, after performing the redundant setting of a line by providing the line connection setting information and the line of the database portion to the hardware portion, the control command is not requesting a change of a connection destination.

[6] In the above-mentioned generic concept device, in the mode of the present invention corresponding to the above-mentioned mode [2], the above-mentioned firmware portion may be composed of an application portion and a database portion, and the application portion may store line connection setting information of the active line stored in the database portion in a new table, may store the line connection setting information of the change request line in the database portion to perform a redundant management of line connection setting information, and may control the hardware portion to switch over the active line to the change request line by releasing a line setting of the active line based on the new table when it is analyzed that, after performing the redundant setting of a line by providing the line connection setting information and the line of the database portion to the hardware portion, the control command is requesting a change of a connection destination.

[7] In the above-mentioned generic concept device, in the mode of the present invention corresponding to the above-mentioned mode [3], the above-mentioned firmware portion may be composed of an application portion and a database portion, and when it is analyzed that the control command is requesting broadcasting by a plurality of lines whose types are different from that of the active line, the application portion may store line connection setting information of the active line stored in the database portions in a new table and may store line connection setting information of a plurality of lines in the database portion to perform a redundant management of line information and may perform a redundant setting of a line by providing the line connection setting information of the database portion to the hardware portion, and then may control the hardware portion to switch over a part of a plurality of lines for which a change of a connection destination is not requested from the active lines to a channel area of a part of lines whose connection destinations are the same as that of the active line and whose types are different from that of the active line by controlling a compulsory switchover of a line switch of the hardware portion.

It is to be noted that the application portion in the above-mentioned mode [5] or [7] may release the line setting of the active line by the line connection setting information of the new table, and may release the compulsory switchover of the line switch. Also, after the line setting release, the line information in the new table may be cleared.

The above-mentioned new table may be provided in the application portion or the database portion.

[8] In the above-mentioned generic concept device, the mode of the present invention corresponding to the above-mentioned mode [4] may comprise: an input/output portion which can input/output a control command; a firmware portion which analyzes the control command to generate line connection setting information; and a hardware portion which performs a line connection per line type according to the line connection setting information; the firmware portion may set, when it is analyzed that the control command is requesting a setting of a line whose new setting is desired per bandwidth and by a desired type, the line by the type and per bandwidth.

The above-mentioned hardware portion may comprise a DS1 unit, an STS switch fabric, a VT switch fabric and an OCn unit, and the control command may comprise a TL1 command composed of a storing slot number to the hardware portion of each unit, a port number on a network side of each unit and a channel number on each switch fabric side of each unit.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a flowchart for illustrating a generic concept of a line connection changing method and device according to the present invention;

FIGS. 2A-2D are diagrams showing a hardware portion and a database portion before changing a line type in a transmission device used as a mode [1] of a line connection changing method and device according to the present invention;

FIGS. 3A-3C are diagrams showing a state when a redundant management and a redundant setting of a line are performed in the transmission device shown in FIGS. 2A-2D;

FIGS. 4A-4C are diagrams showing a state when an active line is switched over to a change request line by a line switch (path switch) from the state shown in FIGS. 3A-3C;

FIGS. 5A-5C are diagrams showing a state when the setting of the active line in the state shown in FIGS. 4A-4C is released;

FIGS. 6A-6C are diagrams showing a state when the line connection setting information of the active line stored in the new table in a state shown in FIGS. 5A-5C is cleared;

FIGS. 7A-7D are diagrams showing an initial state of a hardware portion and a database portion before changing a line type in a transmission device used as a mode [2] of a line connection changing method and device according to the present invention;

FIGS. 8A-8C are diagrams showing a state when a redundant management and a redundant setting of a line are performed in the transmission device shown in FIGS. 7A-7D;

FIGS. 9A-9C are diagrams showing a state when the line setting of the active line in the state shown in FIGS. 8A-8C is released;

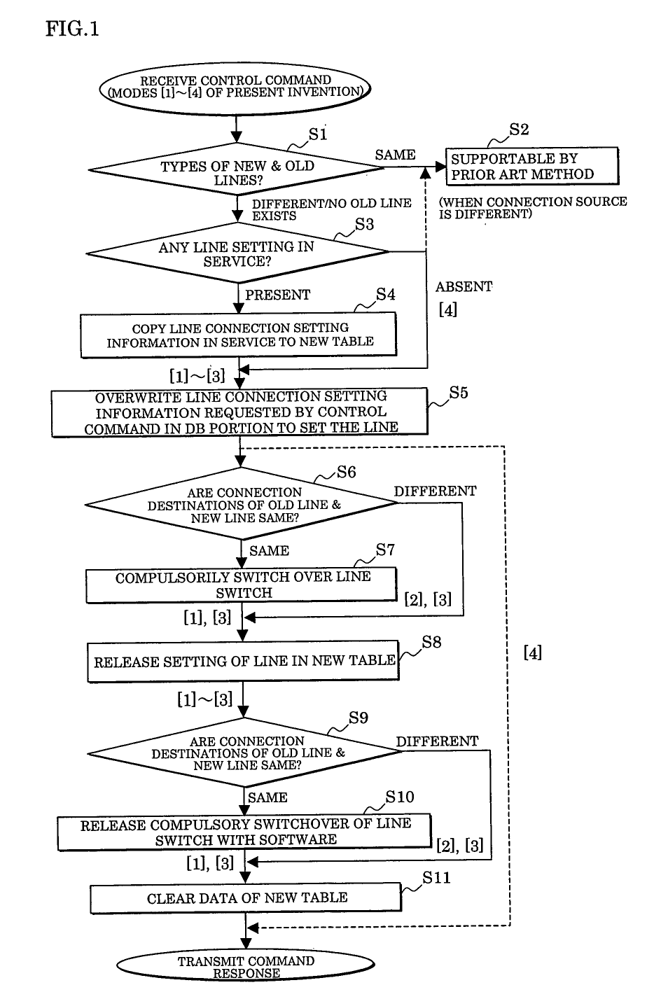

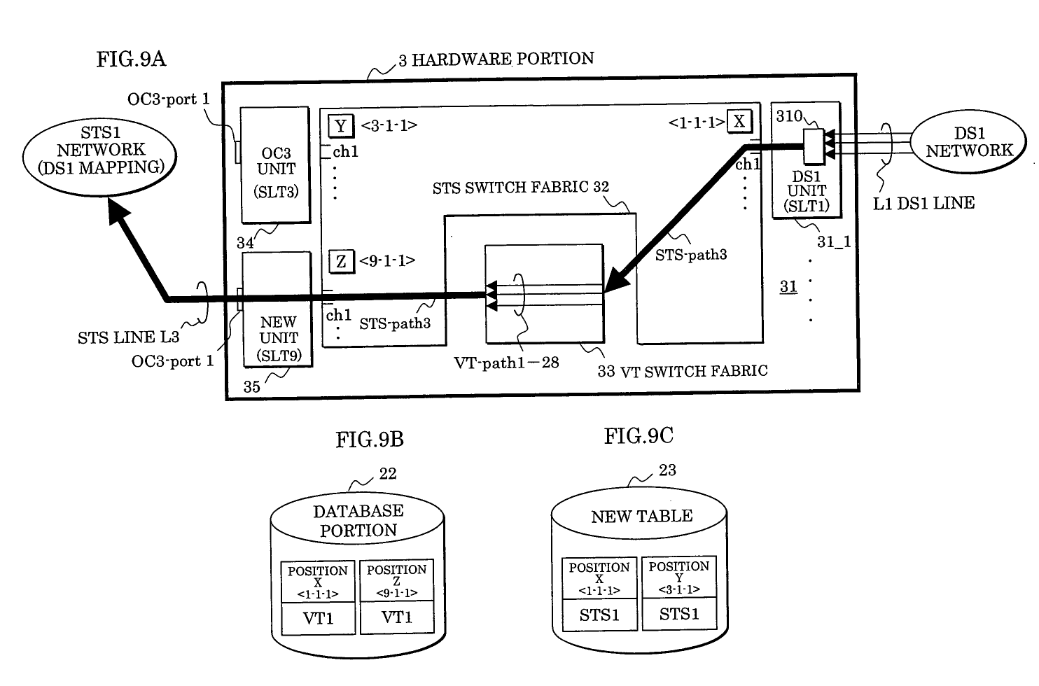

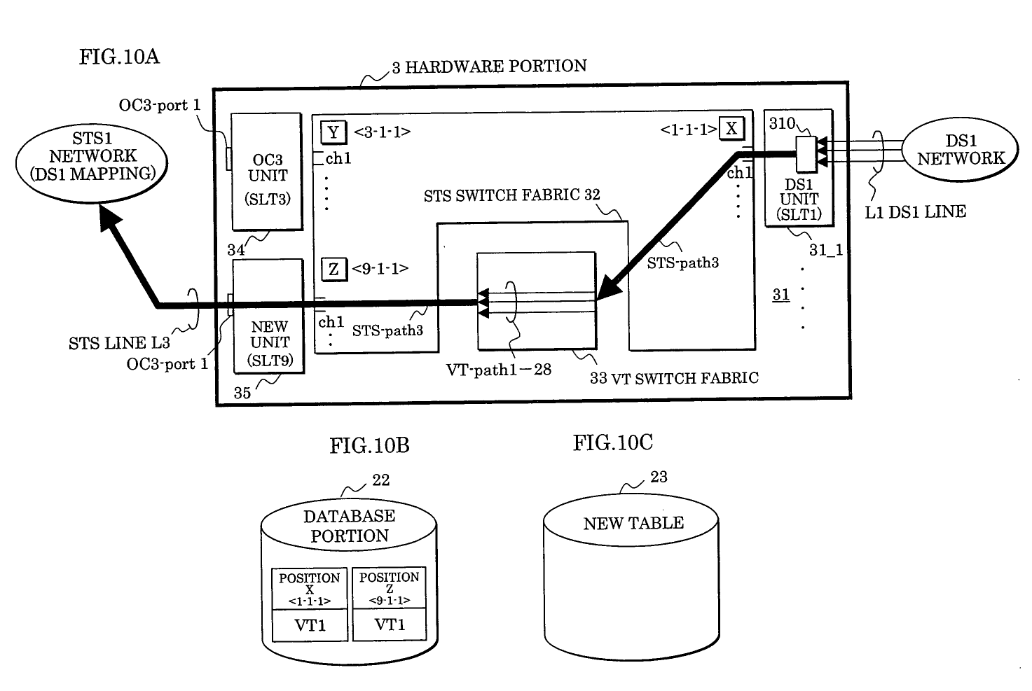

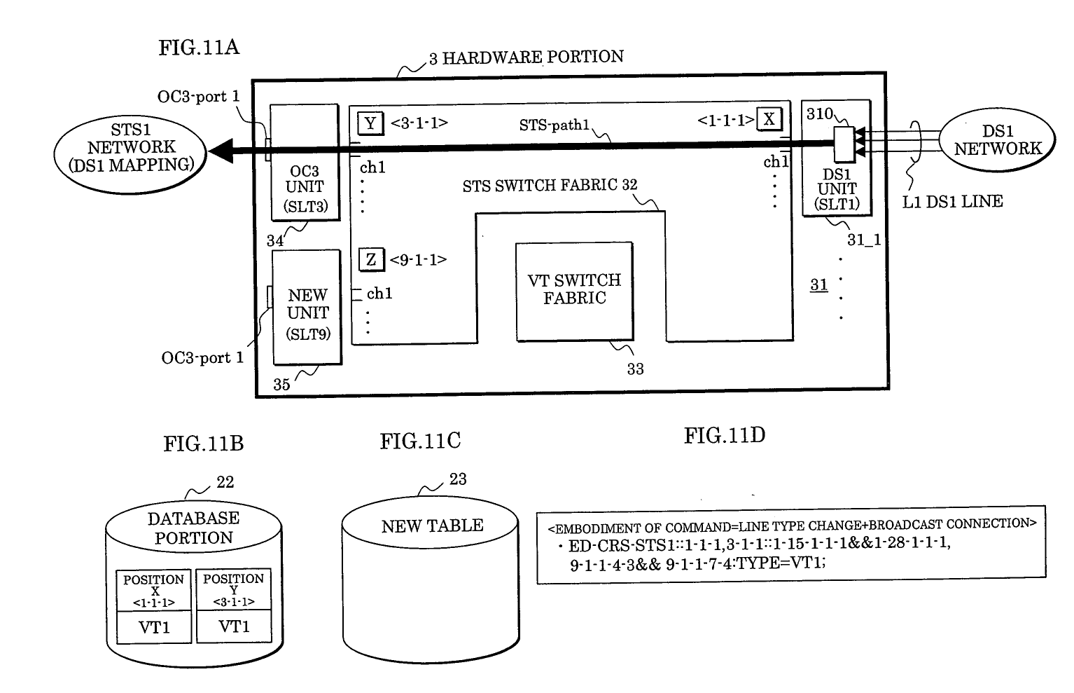

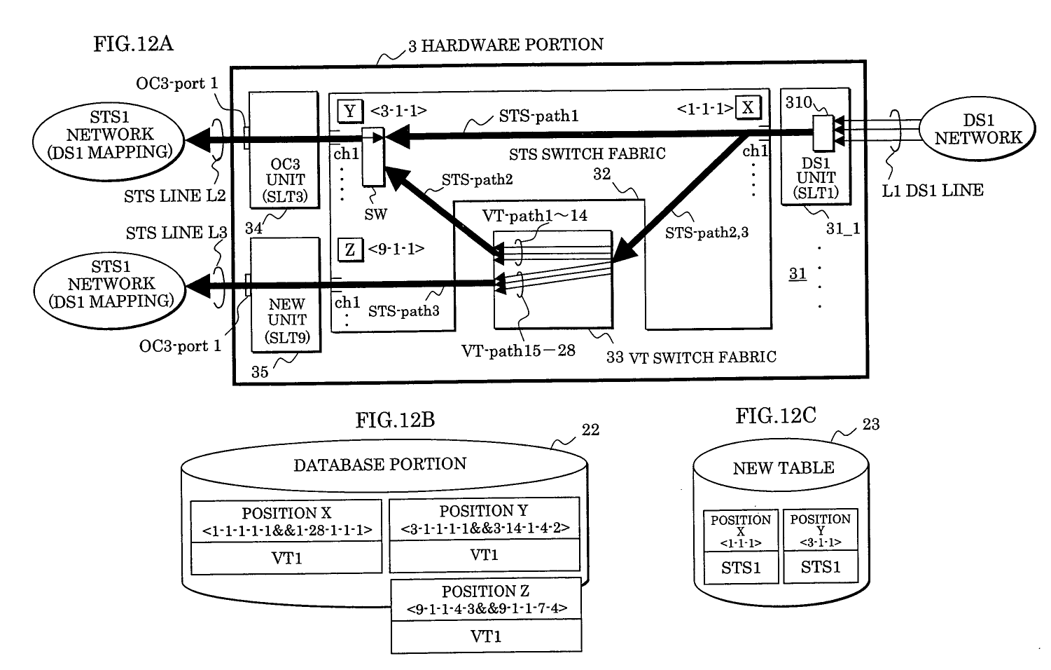

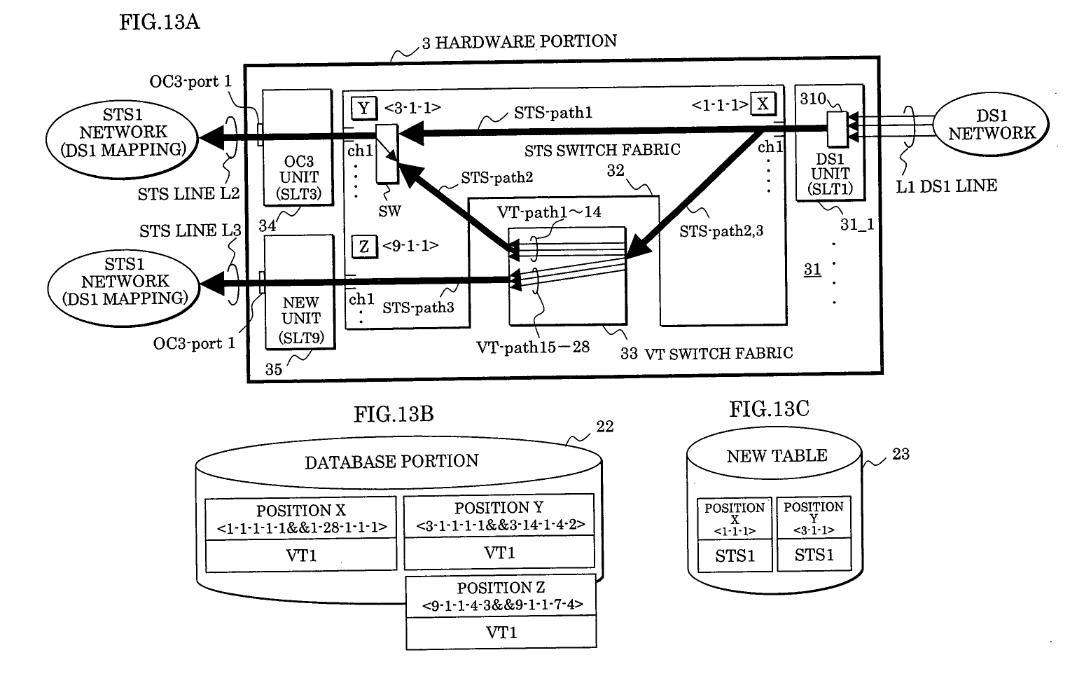

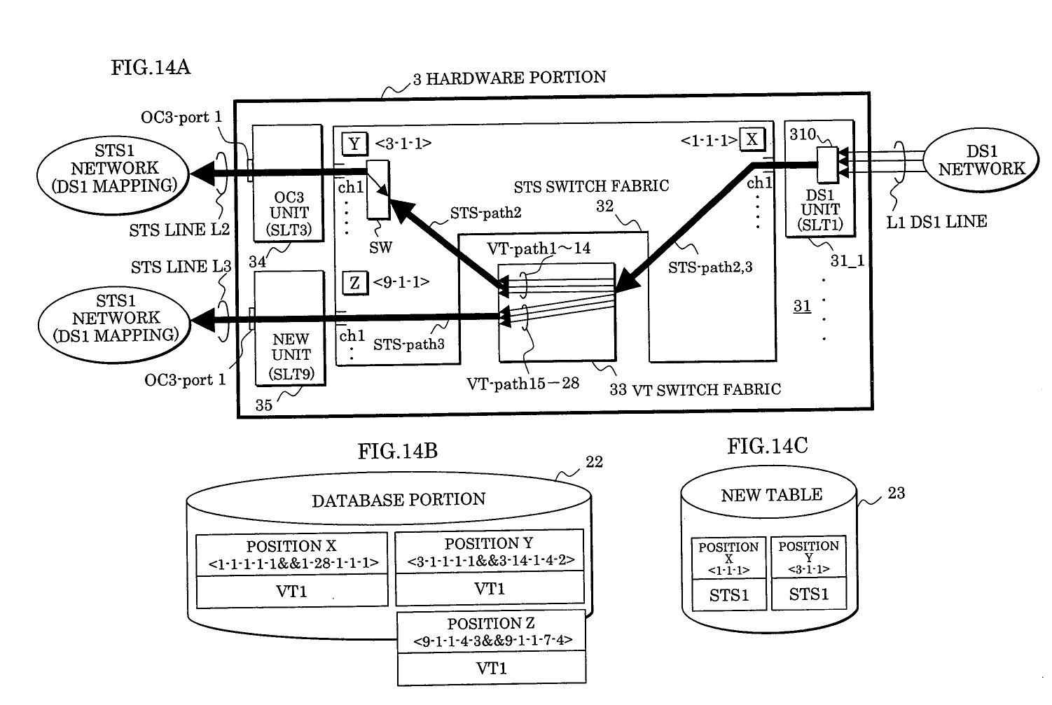

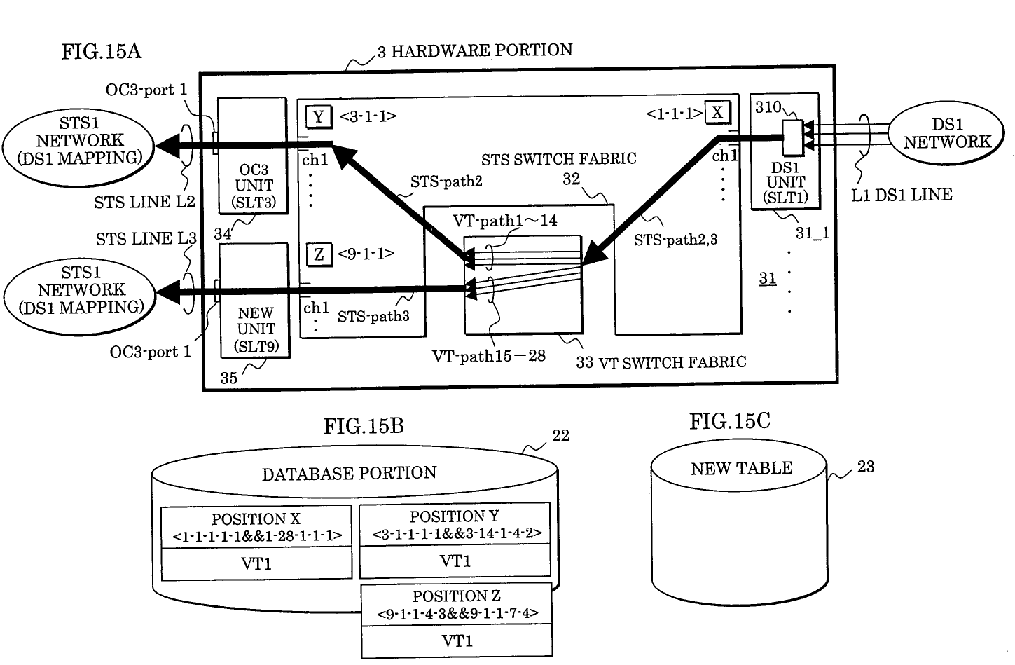

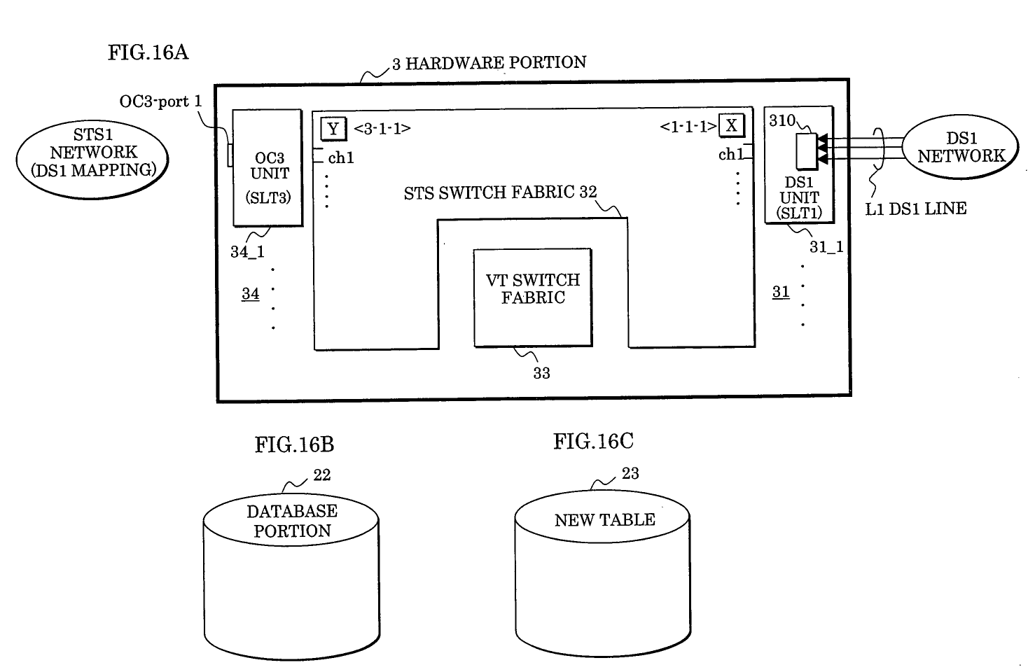

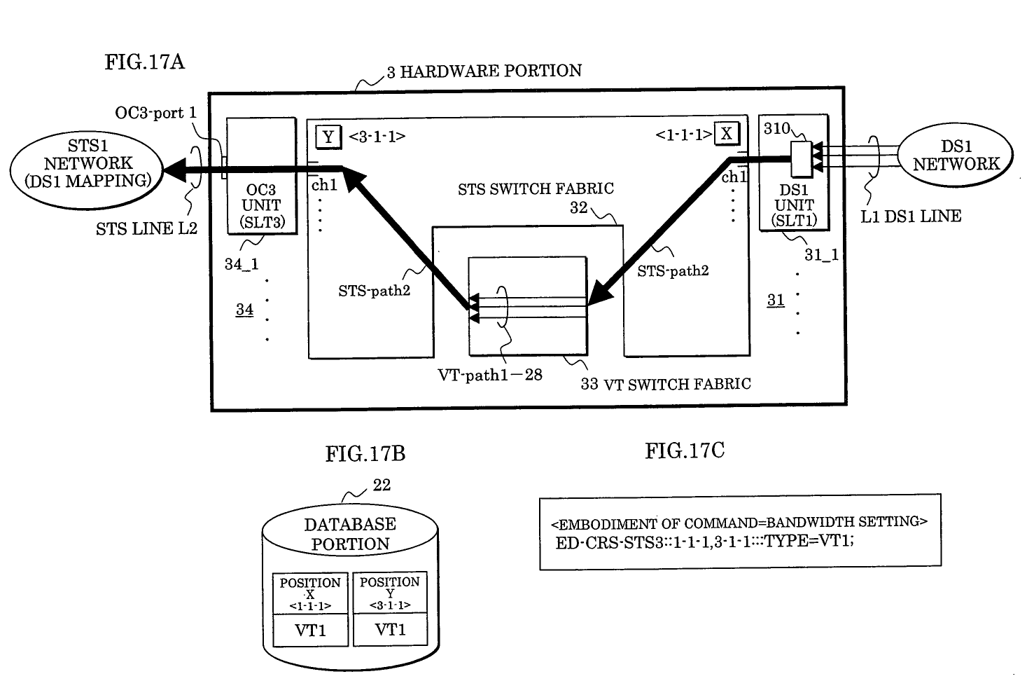

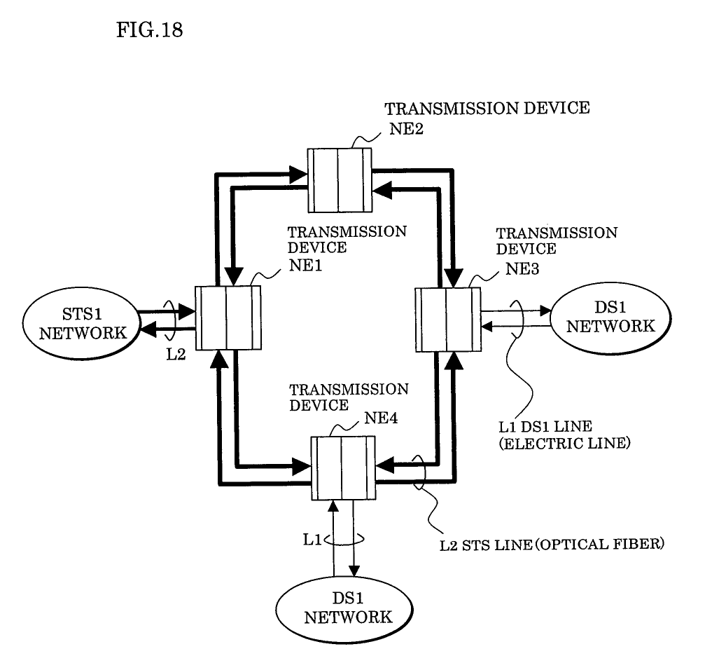

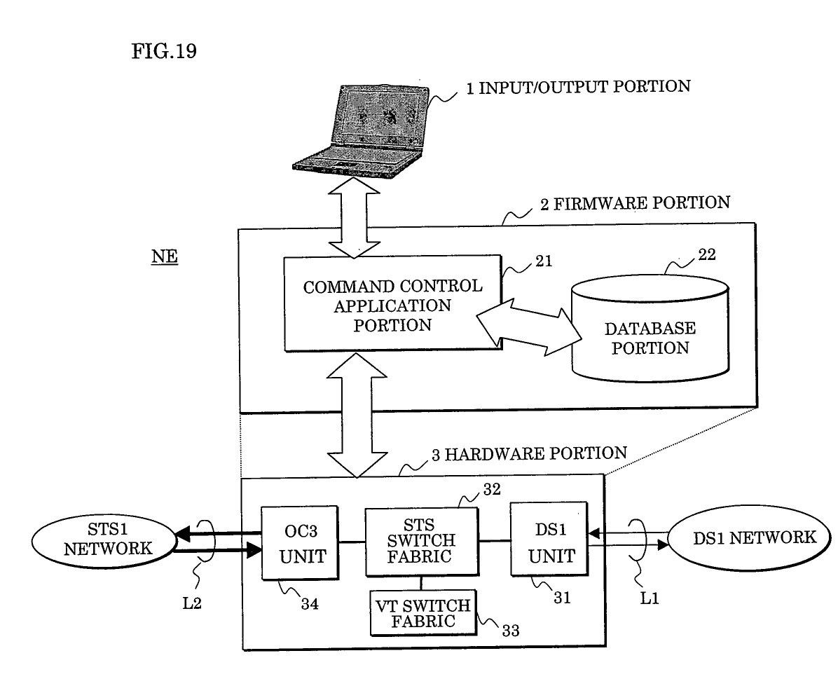

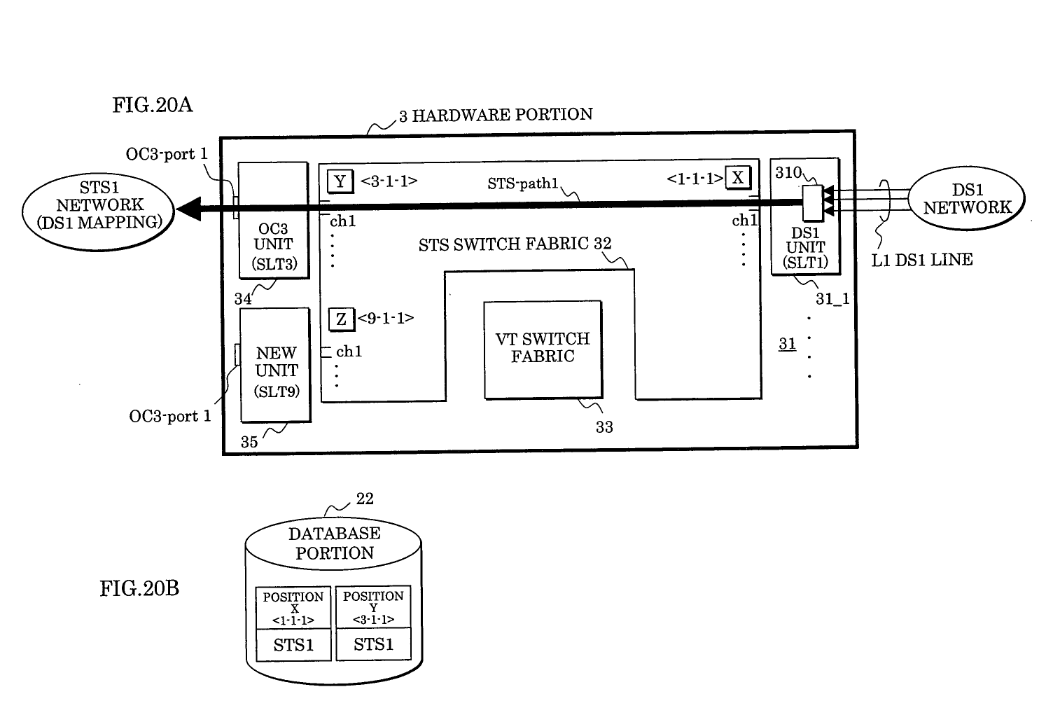

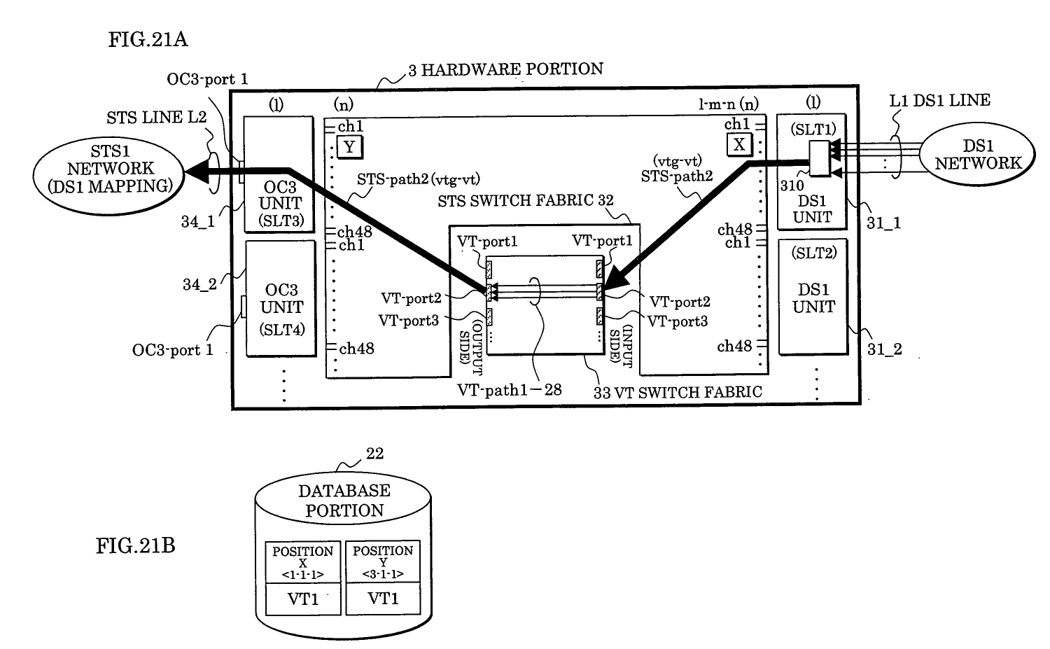

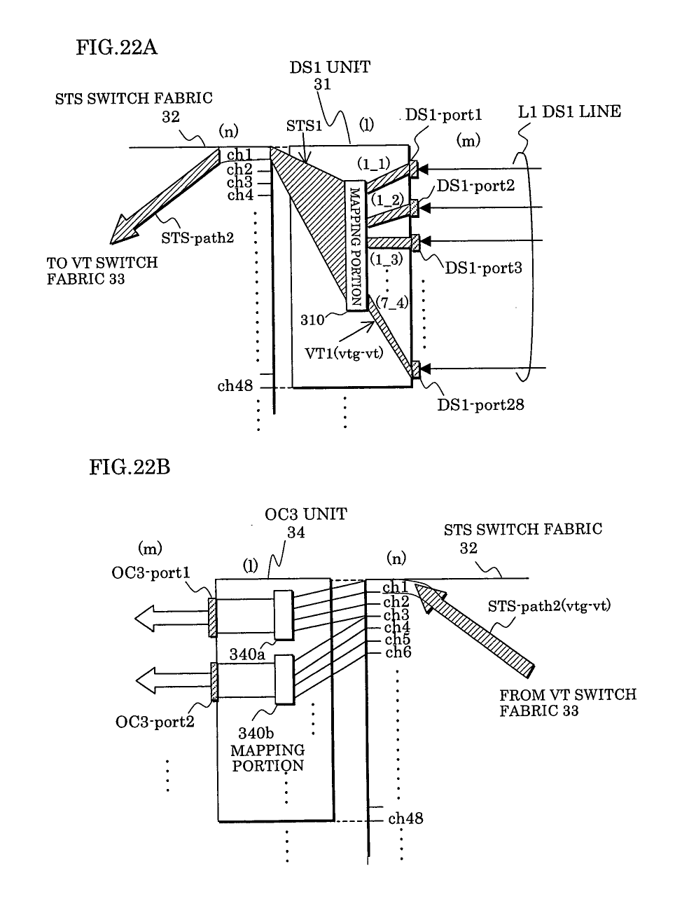

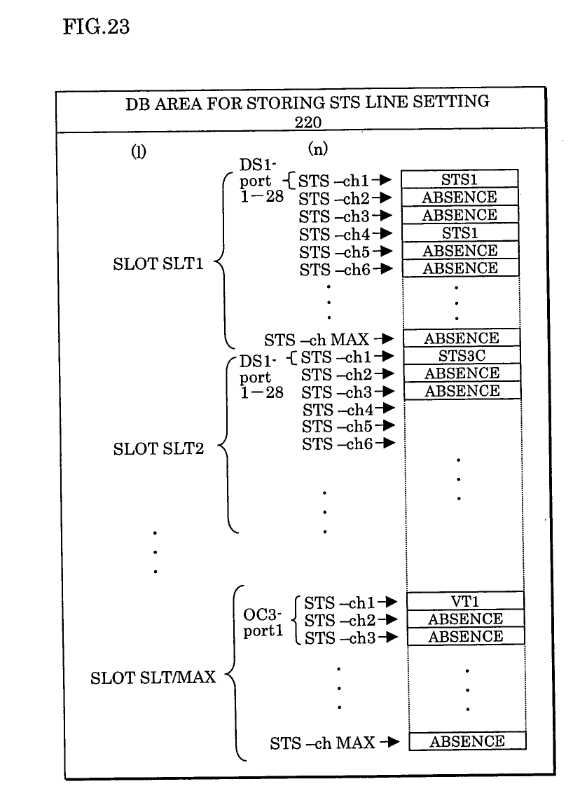

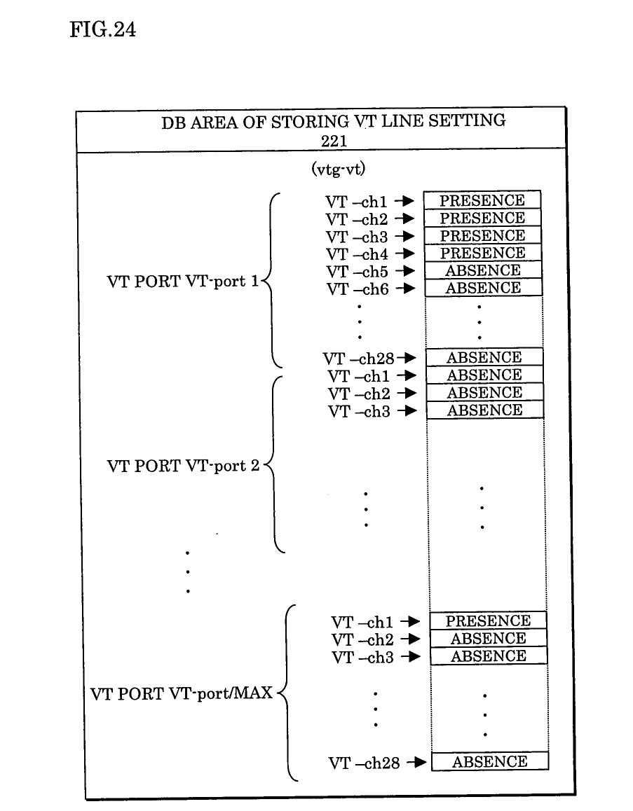

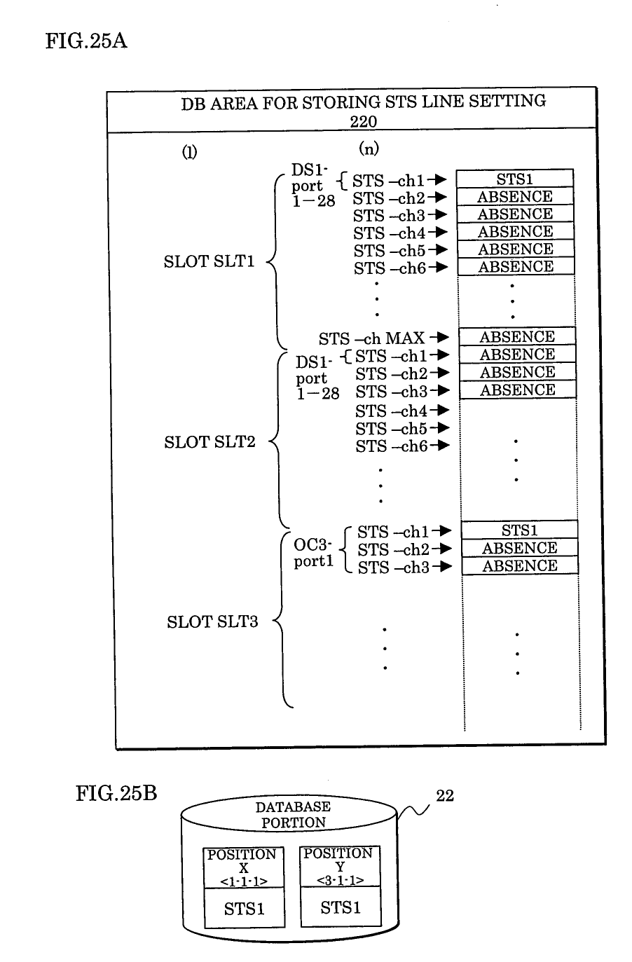

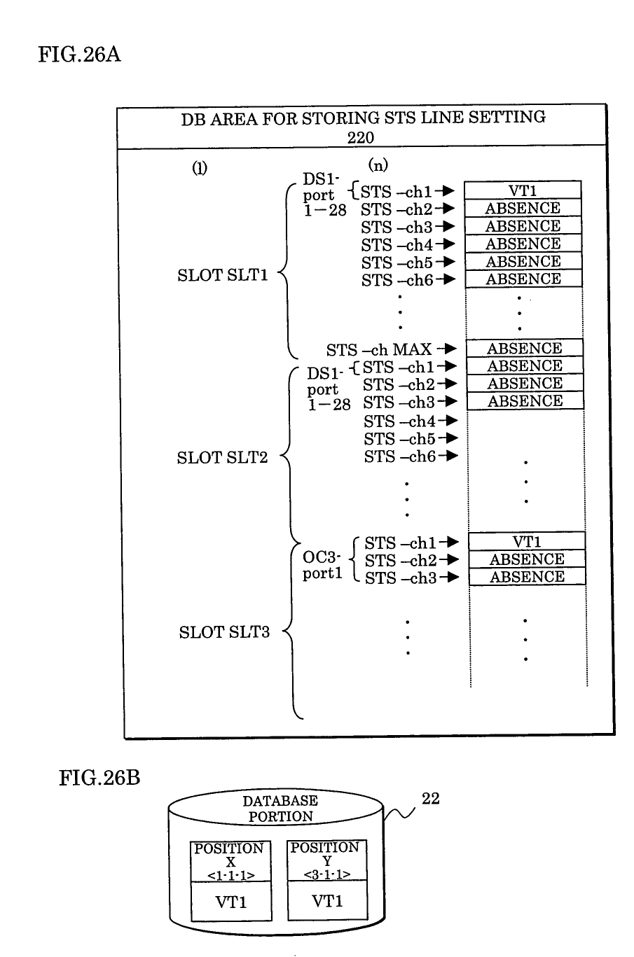

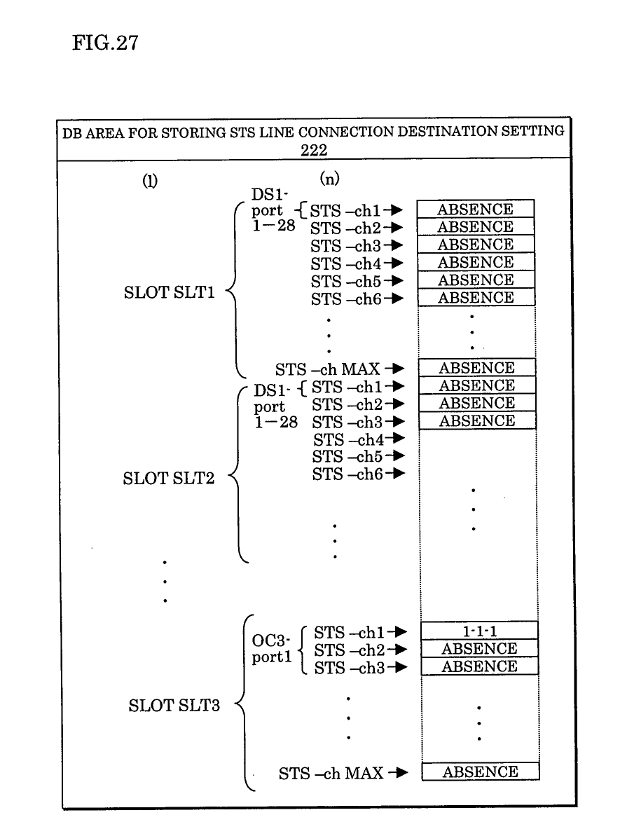

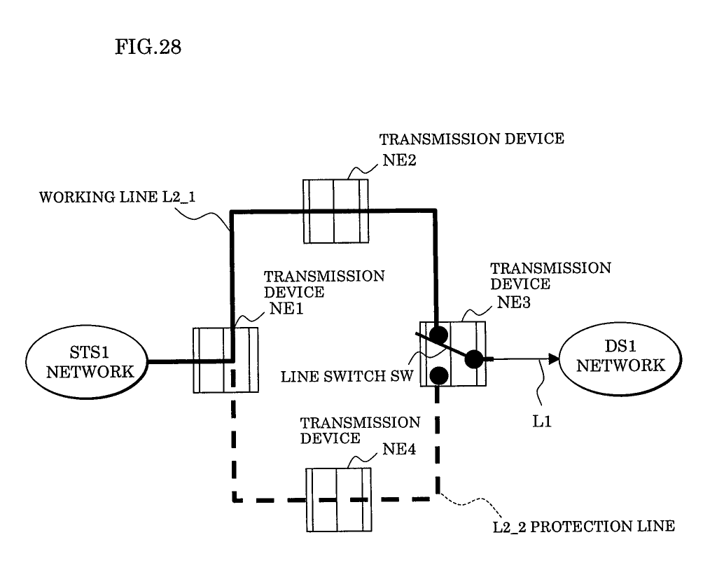

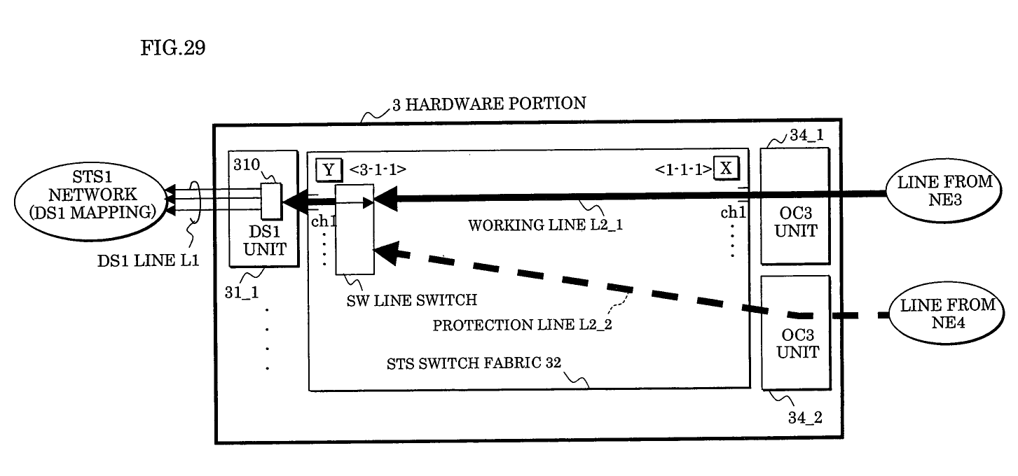

FIGS. 1A-1C are diagrams showing a state when the line connection setting information of the active line stored in the new table in the state shown in FIGS. 9A-9C is cleared;

FIGS. 11A-11D are diagrams showing an initial state before changing a line type and performing a broadcast connection in a transmission device used as a mode [3] of a line connection changing method and device according to the present invention;

FIGS. 12A-12C are diagrams showing a redundant management and a redundant line setting when a line type is changed from the initial state of FIGS. 11A-11D and a broadcast connection is performed;

FIGS. 13A-13C are diagrams showing a state when a part of the broadcast lines are switched over to active lines in the state shown in FIGS. 12A-12C;

FIGS. 14A-14C are diagrams showing a state when the setting of the active line in the state of FIGS. 13A-13C is released;

FIGS. 15A-15C are diagrams showing a state when the line connection setting information in the new table in the state of FIGS. 14A-14C is cleared;

FIGS. 16A-16C are diagrams showing an initial state in a transmission device used as a mode [4] of a line connection changing method and device according to the present invention;

FIGS. 17A-17C are diagrams showing a state when a line setting per bandwidth is performed from the initial state shown in FIGS. 16A-16C;

FIG. 18 is a block diagram showing a general arrangement of a SONET network;

FIG. 19 is a diagram showing a general arrangement of each transmission device shown in FIG. 18;

FIGS. 20A and 20B are diagrams showing a setting example of an STS line in the transmission device in FIG. 19;

FIGS. 21A and 21B are diagrams showing a state when the setting is changed from the STS line setting state to the VT1 line setting in FIGS. 20A and 20B;

FIGS. 22A and 22B are magnified diagrams showing in detail the DS1 unit and the OC3 unit shown in FIGS. 21A and 21B;

FIG. 23 is a diagram showing a general STS line setting storing database area;

FIG. 24 is a diagram showing a general VT line setting storing database area;

FIGS. 25A and 25B are diagrams showing the STS line setting storing database area corresponding to FIGS. 20A and 20B;

FIGS. 26A and 26B are diagrams showing the STS line setting storing database area corresponding to FIGS. 21A and 21B;

FIG. 27 is a diagram showing a general STS line connection destination setting storing database area;

FIG. 28 is a block diagram showing one example of a general UPSR network; and

FIG. 29 is a diagram for illustrating a line (path) switch used for an STS switch fabric in a hardware portion in a UPSR network.

### DESCRIPTION OF THE EMBODIMENTS

Mode [1] of the Present Invention: Line Type Change

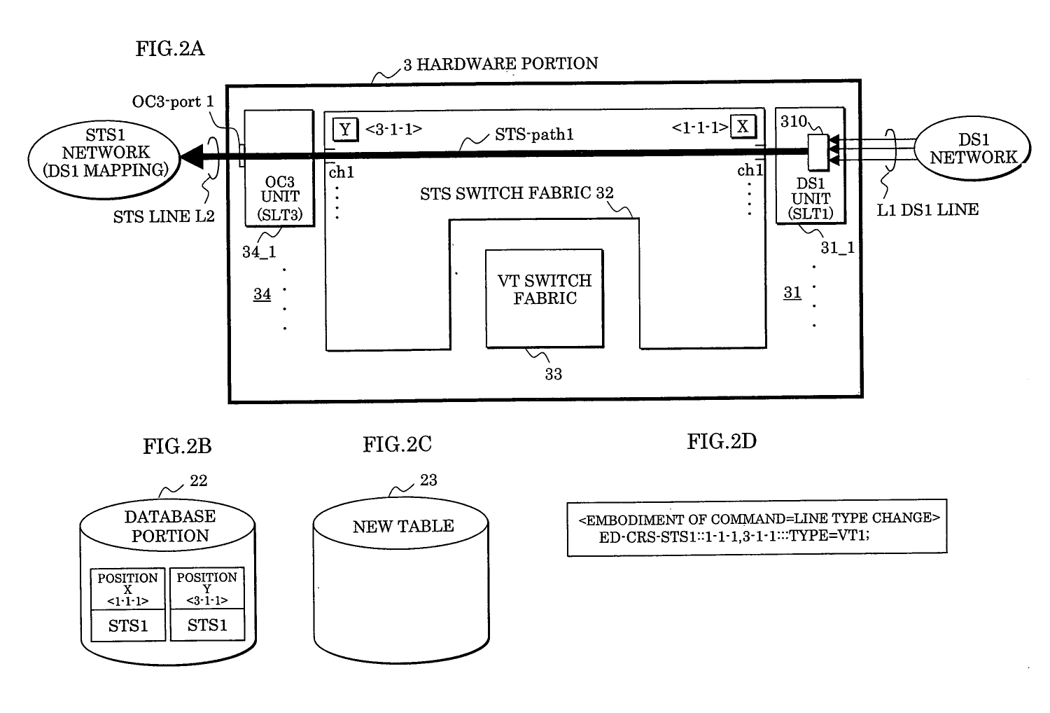

The mode [1] of the present invention shows an embodiment of changing a type from an STS1 line to a VT1 line. FIGS. 2A-2D show its initial state, which is basically the same as the prior art STS1 line setting example shown in FIGS. 20A and 20B.

However, in the case of the present invention, different from the prior art example, a new table 23 shown in FIG. 2C is provided and a control command of a TL1 command form as shown in FIG. 2D is used.

Firstly, the control command will now be described. The control command is composed of following five setting items.
1. Existing connection destination
2. Existing connection source
3. New connection destination
4. New connection source
5. New line type

The image of this control command is as follows:

ED-CRS-<existing bandwidth type>::<existing connection source>::<existing connection destination>::<new connection source 1>, <new connection destination 1>, <new connection source 2>, <new connection destination 2>, . . . : TYPE=<new line type>

It is to be noted that in the following, the omission of the description of the new connection destination and the new connection source will mean a return to the existing line (active line) position.

Thus, the embodiment of the command shown in FIG. 2D,

“ED-CRS-STS1::1-1-1, 3-1-1: : : TYPE=VT1;” (ED indicates edit) indicates that the command is provided from the input/output portion 1 to the firmware portion 2 shown in FIG. 19 so that only the line type having been set from the slot SLT1 to the slot SLT3 with the STS1 is changed to the VT1, and that the firmware portion 2 further commands the STS switch fabric 32 or the VT switch fabric 33 in the hardware portion 3.

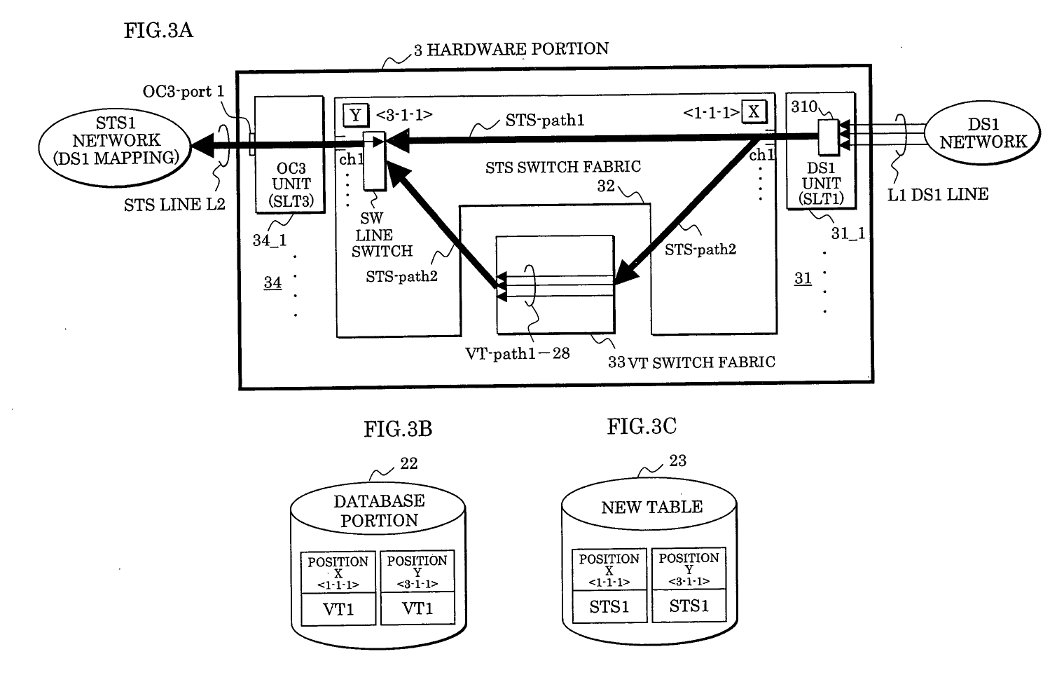

Namely, when the control command is provided from the input/output portion 1 to the application portion 21 in the firmware portion 2, the application portion 21 prepares the line connection setting information concerning the line presently in service stored in the database portion 22 shown in FIG. 2B to be copied to the new table 23 shown in FIG. 2C. Thus, as shown in FIG. 3C, the same line connection setting information as FIG. 2B is stored in the new table 23.

Concurrently, as shown in FIG. 3B, a line type which an operator desires to change is overwritten in the database portion 22. Accordingly, the line is changed to the VT1 line respectively for the same line positions X and Y in the database portion 22. Thus, the redundant management of the line is enabled with the database portion 22 and the new table 23, and the prior art problem of overwriting the line with a line of a different type can be solved.

Accordingly, as shown in FIG. 3A, in addition to an STS-path1 concerning the line in service based on the line connection setting information stored in the new table 23, an STS-path2 is set in parallel from the position X based on the line connection setting information within the database portion 22. The STS-path2 is branched from the STS1 line at the VT switch fabric 33, so that the port number of the DS1/OC3 unit=28 channels of VT1 channels (VT-path1-28: VT-ch1-VT-ch28 of FIG. 24) are set. This STS-path2 corresponds to the STS-path2 shown in FIG. 21A.

As mentioned above, since the STS-path2 has the same connection destination, it is connected to the line switch SW. Accordingly, as shown in FIG. 3A, the STS-path1 and the STS-path2 accommodating the VT-path1-28 are in a parallel state where it is ready to switchover the line by the line switch SW.

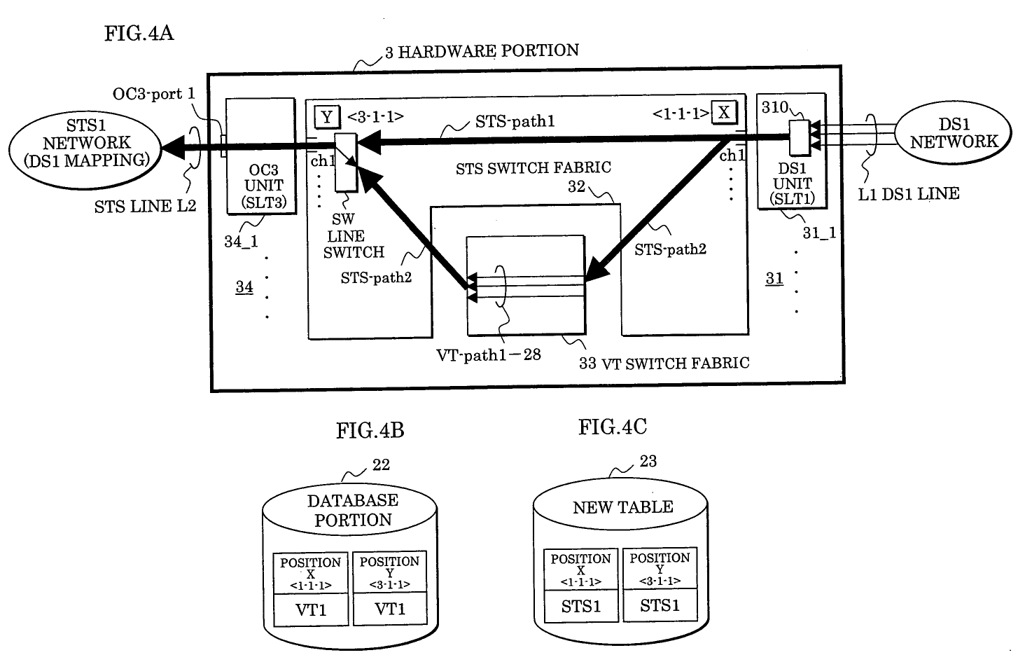

Since the line switch SW selects the STS-path1 of the working line originally set as shown in FIG. 3A, the application portion 21 compulsorily switches over the line switch SW with the software, so that the line switch SW selects the new STS-path2 as shown in FIG. 4A. Therefore, whether or not the line destination of the new table 23 and the database 22 are the same is checked. Since the position Y is the same, a compulsory switchover of a main signal is set by the line switch SW.

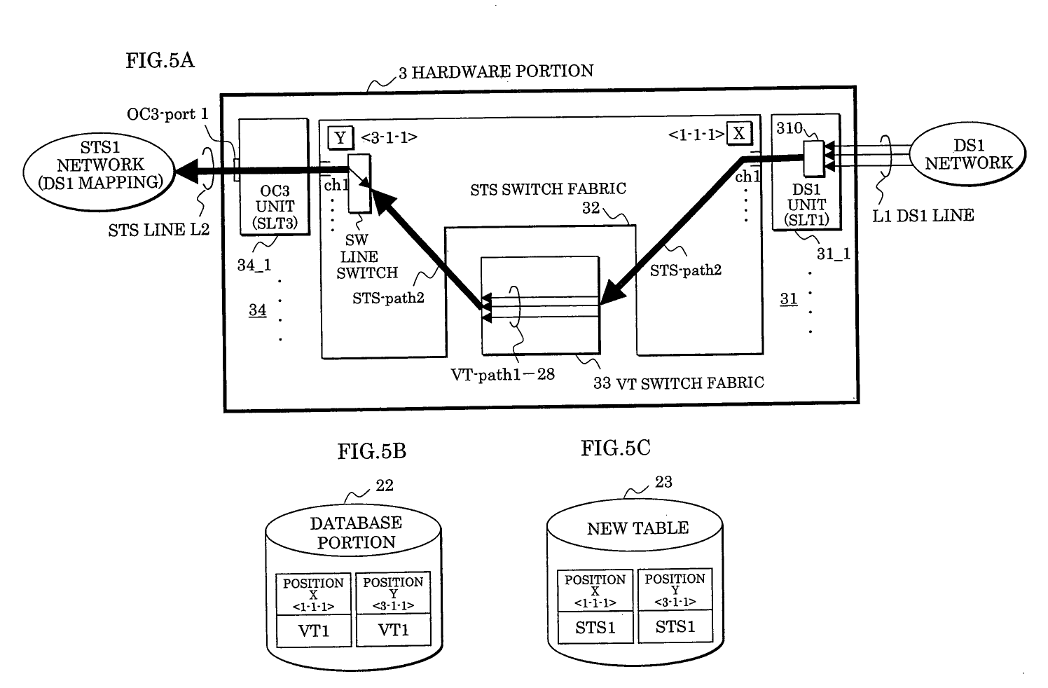

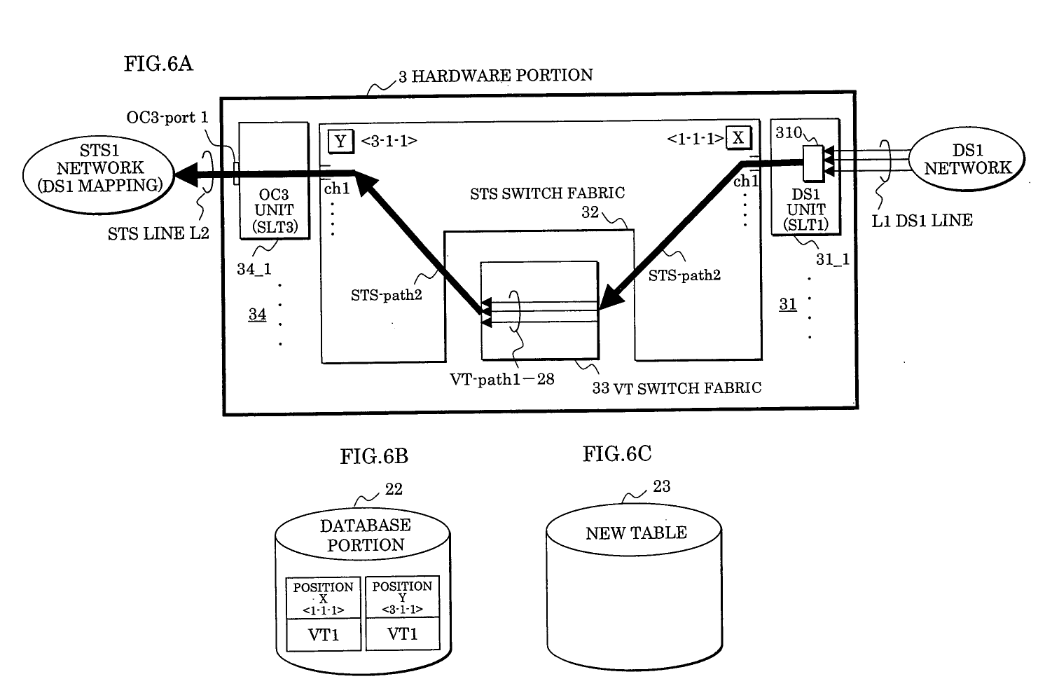

Hereafter, as shown in FIG. 5A, the setting of the STS-path1 of the active line is released, and the line switch SW is compulsorily switched over with the software as shown in FIG. 6A, and the data of the new table 23 are cleared as shown in FIG. 6C.

Thus, bothersome operations of setting the VT1 line for 28 channels, namely 28 times of line setting operation required after having released the line setting of the STS-path1 in the conventional technology can be realized with only a single operation in the present mode [1].

Also, since the line change is performed by the compulsory switchover after having preset a change line (VT-path1-28 in this example), the line type can be changed in service with an instantaneous disconnection (within −50 msec) upon the compulsory switchover in the line switch SW.

Mode [2]of the Present Invention: Line Type Change+Line Shift

This mode shows a case where the STS line (STS-path1) is changed to the line type of the VT1 and the connection destination is shifted.

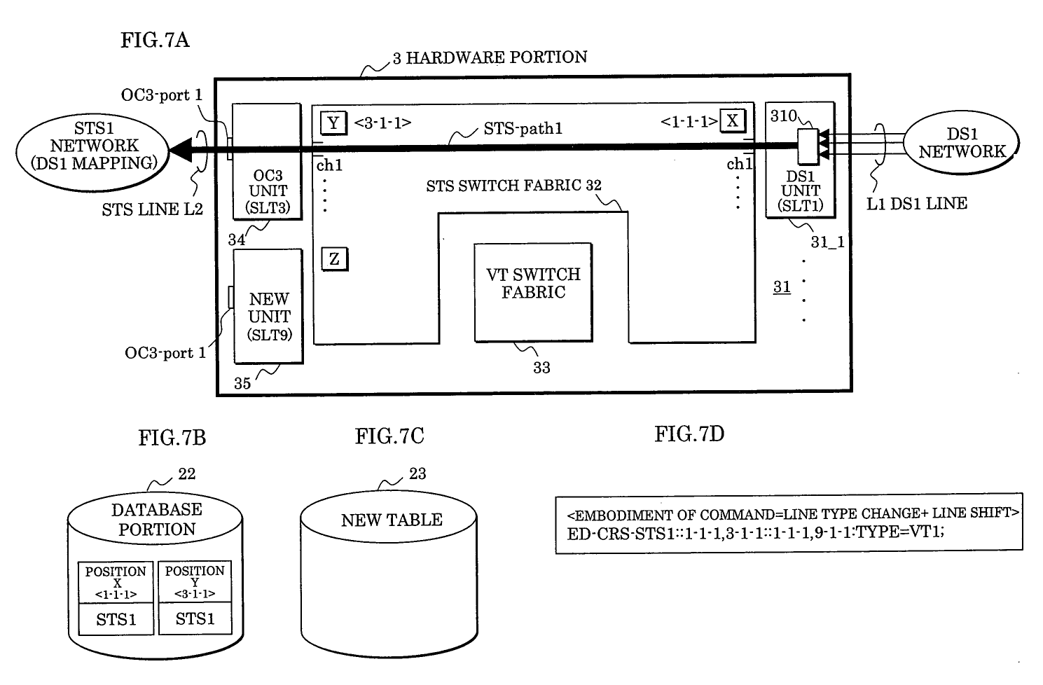

Namely, in FIG. 7A corresponding to the initial state of FIG. 2A, the control command,

“ED-CRS-STS1::1-1-1, 3-1-1::1-1-1, 9-1-1:TYPE=VT1;”

shown in FIG. 7D is received. This is for changing the line set from the slot SLT1 to the SLT3 with the STS1 to another line type VT1 and to shift the line to the new unit 35 mounted in the slot SLT9.

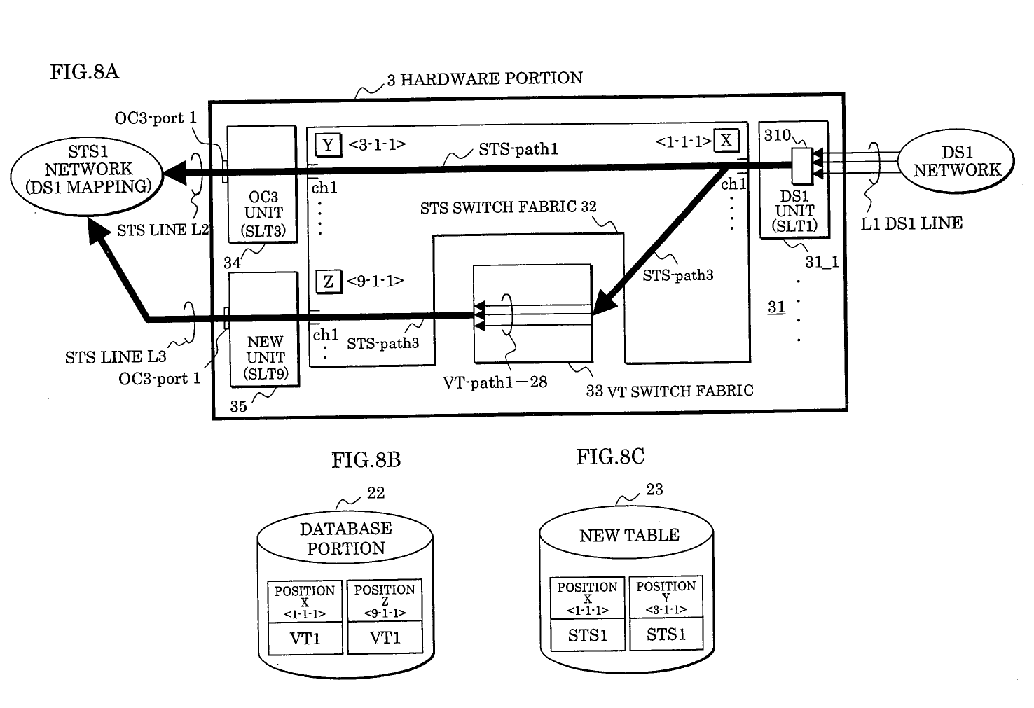

Therefore, in a state where the STS-path1 having the existing connection source X=1-1-1 and the existing connection destination Y=3-1-1 is set as shown in FIG. 7A, as is the above-mentioned mode [1], the line connection setting information of the existing STS-path1 stored in the database portion 22 is copied and stored in the new table 23 as shown in FIG. 8C.

In order to set a new VT1 line having a new connection source 1(X)=1-1-1 and a new connection destination 1(Z)=9-1-1, a position X and a position Z of the new unit 35 are set for the VT1 line in the database portion 22 as shown in FIG. 8B, thereby setting the STS1-path3 from the position X of the STS switch fabric 32 through the VT switch fabric 33 and the position Z of the STS switch fabric 32 to the new unit 35 mounted in the slot SLT9 as shown in FIG. 8A.

As shown in FIG. 9A, the setting of the old active line STS-path1 is released, and the old line data stored in the new table 23 are cleared as shown in FIG. 10C, thereby enabling the line type change and the shift to be performed.

Accordingly, in the present invention, the original line is released after a line to be shifted or to be changed is preset and the line (VT-path1-28 in this case) is set. Therefore, a line type change and shift in service are made possible.

Mode [3] of the Present Invention: Line Type Change and Broadcast Connection

In this mode, the type of the STS1 line (STS-path1) as shown in FIG. 11A is changed to the VT1 line, and a broadcast connection to both of the line for which the shift is desired and an original line is performed. The VT-path1-14 supposed to be original line and the VT-path15-28 supposed to be lines to be shifted are taken as specific examples for the following description.

The control command example in this case is as shown in FIG. 11D,

“ED-CRS-STS1::1-1-1,3-1-1::1-15-1-1-1&&1-28-1-1-1-,9-1-1-4-3&&9-1-1-7-4:TYPE=VT1;”

which is provided from the input/output portion 1 to the firmware portion 2. It is to be noted that “&&” in the above command indicates a range between channels. In this case, a channel range from the VT-ch15 to the VT-ch28 is indicated.

This control command indicates that the STS-path1 having the existing connection source X=1-1-1 and the existing connection destination Y=3-1-1 is branched to the STS-path2 and 3. The STS-path3 is assigned to the VT1 paths (VT-path15-28) which connect connection sources of {the new connection source 1(X)=1-15-1-1-1 to the new connection source 28(X)=1-28-1-1-1} to connection destinations of {the new connection destination 1(Z)=9-1-1-4-3 to the new connection destination 28(Z)=9-1-1-7-4}, to be shifted to the new unit 35 mounted in the slot SLT9. The other STS-path2 is assigned to the VT-path1-14 (position Y=3-1-1-1-1&&3-14-1-4-2) to return to the line switch SW and be connected.

Accordingly, the line connection setting information of the old line stored in the database portion 22 shown in FIG. 11B is firstly copied and saved in the new table 23 as shown in FIG. 12C.

Then, as shown in FIG. 12B, the VT1 which is a different line type respectively for the positions X, Y, and Z in the STS switch fabric 32 is set in the database portion 22, and a redundant management of the line is performed in the new table 23 and the database portion 22.

Thus, the STS-path2 and 3 branched from the position X of the STS switch fabric 32 are divided into two, the VT-path1-14 and the VT-path15-28 in the VT switch fabric 33. One of them is connected as the STS-path2 to the line switch SW whose connection destination is the same as that of the STS-path1, while the other is connected as the STS-path3 to the new unit 35 from the position Z. Thus, redundancy of line is realized.

Hereafter, line switchover is performed between the STS-path1 and the STS-path2 by the line switch SW (see FIG. 13A). Therefore, as mentioned above, whether or not the line destinations of the new table 23 and the database 22 are the same is checked. Since the position Y is the same, a compulsory switchover of a main signal is set by the line switch SW.

In the same way as the above, the older line, STS-path1 is deleted based on the new table 23 (see FIG. 14A).

Then, as shown in FIG. 15A, a compulsory switchover setting in the line switch SW is released, and the line connection setting information stored in the new table 23 is deleted as shown in FIG. 15C.

Thus, in the mode [3], a line change is performed only with a single operation by compulsorily switching over the line switch after having preset the line to be changed. Therefore, it becomes possible to perform a change of the line type and the broadcast connection in service state with an instantaneous disconnection upon a compulsory switchover within a permissible time.

Mode [4] of the Present Invention: Line Setting per Bandwidth

In this mode, the line setting of the VT1 is performed per bandwidth. This control command is, as shown in FIG. 17C,

“ED-CRS-STS1::1-1-1, 3-1-1:::TYPE=VT1;”.

This indicates that the VT1 line having the existing connection source X=1-1-1 and the existing connection destination Y=3-1-1 is newly set from the SLT1 to the slot SLT3.

Thus, according to the line position which a user desires as shown in FIG. 17A, the setting of the VT1 line (VT-path1-28) for 28 channels is performed. It is to be noted that the bandwidth setting in this case indicates that the “STS1” in the “ED-CRS-STS1” is an STS1 bandwidth. When an STS3 bandwidth is desired, “STS3” may be designated as follows:
Bandwidth Type
STS1 VT1→setting of VT-path-1-28
STS3C VT1→setting of VT-path-1-84 (28×3)
STS3C STS1→setting of STS1-3

Thus, it becomes possible to set the VT1 line of a desired bandwidth by a single operation in the present invention.

As described above, by a line connection changing method and device according to the present invention, when it is analyzed that a control command is requesting a type change of an active line, a change request line in addition to the active line is redundantly managed, and a redundant setting of a line is performed based on line connection setting information of the change request line, and a switchover of the active line to the change request line is performed depending on whether connection destinations of both lines are different or same. Therefore, the following effects can be obtained.
1. A type change of a line connection in service can be realized.
2. Not only the line connection type is changed within a line position presently used, but also a line connection itself can be shifted to an arbitrary place which a user desires. This is very effective, for example, when an upgrade to a unit newly developed from a line used presently is desired.
3. Since the line change setting or a band setting can be performed by a single operation, bothersome operations are not required.
4. A line setting of a bandwidth desired is made possible.

1. A line connection changing method comprising the steps of:
analyzing a control command inputted to generate line connection setting information;
performing a line connection per line type according to the line connection setting information;
redundantly managing, when it is analyzed that the control command is requesting a type change of an active line, a change request line in addition to the active line;
performing a redundant setting of a line based on line connection setting information of the change request line; and
switching over the active line to the change request line depending on whether connection destinations of both lines are different or same.

2. The line connection changing method as claimed in claim 1, further comprising the step of, when it is analyzed that, after performing the redundant setting, the control command is not requesting a change of a connection destination, switching over the active line to the change request line whose connection destination is the same as that of the active line and whose line type is different from that of the active line.

3. The line connection changing method as claimed in claim 2, wherein the control command includes an existing connection source, an existing connection destination and a new connection source.

4. The line connection changing method as claimed in claim 1, further comprising the step of, when it is analyzed that, after performing the redundant setting, the control command is requesting a change of a connection destination, switching over the active line to the change request line by releasing a line setting of the active line.

5. The line connection changing method as claimed in claim 4, wherein the control command includes an existing connection source, an existing connection destination, a new connection source of a new line type and a new line.

6. The line connection changing method as claimed in claim 1, further comprising the step of, when it is analyzed that the control command is requesting broadcasting by a plurality of lines whose types are different from that of the active line, switching over, after performing the redundant setting, a part of the active lines for which a change of a connection destination is not requested from the active lines to a channel area of a part of lines whose connection destinations are the same as that of the active line and whose types are different from that of the active line.

7. The line connection changing method as claimed in claim 6, wherein the control command includes an existing connection source, an existing connection destination, a new line type, a channel area of a new line type whose connection destination is the same as that of the existing connection destination and a channel area of a new connection destination of a new line type broadcasted except the existing connection destination.

8. The line connection changing method as claimed in claim 2, further comprising the step of releasing a line setting of the active line.

9. The line connection changing method as claimed in claim 2, further comprising the step of clearing the line connection setting information of the active line after releasing the line setting.

10. A line connection changing method comprising the steps of:
analyzing a control command inputted to generate line connection setting information;
performing a line connection per line type according to the line connection setting information; and
setting, when it is analyzed that the control command is requesting a setting of a line whose new setting is desired per bandwidth and by a desired type, the line by the type and per bandwidth.

11. The line connection changing method as claimed in claim 10, wherein the control command includes a new connection source, a new connection destination, a bandwidth to be set and a new line type.

12. The line connection changing method as claimed in claim 1, wherein the line type comprises an STS line and a VT line.

13. The line connection changing method as claimed in claim 1, wherein the control command comprises a TL1 command.

14. A line connection changing device comprising:
an input/output portion which can input/output a control command;
a firmware portion which analyzes the control command to generate line connection setting information; and
a hardware portion which performs a line connection per line type according to the line connection setting information;
the firmware portion redundantly managing, when it is analyzed that the control command is requesting a type change of an active line, a change request line in addition to the active line, and performing a redundant setting of a line by providing line connection setting information of the change request line to the hardware portion, and the hardware portion switching over the active line to the change request line corresponding to whether connection destinations of both lines are different or same.

15. The line connection changing device as claimed in claim 14, wherein the firmware portion is composed of an application portion and a database portion, and the application portion stores line connection setting information of the active line stored in the database portion in a new table, stores the line connection setting information of the change request line in the database portion to perform a redundant management of line connection setting information, and switches over the active line to the change request line whose connection destination is the same as that of the active line and whose line type is different from that of the active line by controlling a compulsory switchover of a line switch of the hardware portion when it is analyzed that, after performing the redundant setting of a line by providing the line connection setting information and the line of the database portion to the hardware portion, the control command is not requesting a change of a connection destination.

16. The line connection changing device as claimed in claim 15, wherein the control command includes an existing connection source, an existing connection destination and a new line type.

17. The line connection changing device as claimed in claim 14, wherein the firmware portion is composed of an application portion and a database portion, and the application portion stores line connection setting information of the active line stored in the database portion in a new table, stores the line connection setting information of the change request line in the database portion to perform a redundant management of line connection setting information, and controls the hardware portion to switch over the active line to the change request line by releasing a line setting of the active line based on the new table when it is analyzed that, after performing the redundant setting of a line by providing the line connection setting information and the line of the database portion to the hardware portion, the control command is requesting a change of a connection destination.

18. The line connection changing device as claimed in claim 17, wherein the control command includes an existing connection source, an existing connection destination, a new connection source of a new line type and a new connection destination.

19. The line connection changing device as claimed in claim 14, wherein the firmware portion is composed of an application portion and a database portion, and when it is analyzed that the control command is requesting broadcasting by a plurality of lines whose types are different from that of the active line, the application portion stores line connection setting information of the active line stored in the database portions in a new table and stores line connection setting information of a plurality of lines in the database portion to perform a redundant management of line information and performs a redundant setting of a line by providing the line connection setting information of the database portion to the hardware portion, and then controls the hardware portion to switch over a part of a plurality of lines for which a change of a connection destination is not requested from the active lines to a channel area of a part of lines whose connection destinations are the same as that of the active line and whose types are different from that of the active line by controlling a compulsory switchover of a line switch of the hardware portion.

20. The line connection changing device as claimed in claim 19, wherein the control command includes an existing connection source, an existing connection destination, a new line type, a channel area of a new line type whose connection destination is the same as that of the existing connection destination and a channel area of a new connection destination of a new line type broadcasted except the existing connection destination.

21. The line connection changing device as claimed in claim 15, wherein the application portion releases a line setting of the active line by the line connection setting information within the new table and releases the compulsory switchover of the line switch.

22. The line connection changing device as claimed in claim 15, wherein the application portion clears the line connection setting information of the new table after releasing the line setting.

23. The line connection changing device as claimed in claim 15, wherein the new table is provided in either the application portion or the database portion.

24. A line connection changing device comprising:
an input/output portion which can input/output a control command;
a firmware portion which analyzes the control command to generate line connection setting information; and
a hardware portion which performs a line connection per line type according to the line connection setting information;
the firmware portion sets, when it is analyzed that the control command is requesting a setting of a line whose new setting is desired per bandwidth and by a desired type, the line by the type and per bandwidth.

25. The line connection changing device as claimed in claim 24, wherein the control command includes a new connection source, a new connection destination, a bandwidth to be set and a new line type.

26. The line connection changing device as claimed in claim 14, wherein the line type comprises an STS line and a VT line.

27. The line connection changing device as claimed in claim 14, wherein the hardware portion comprises a DS1 unit, an STS switch fabric, a VT switch fabric and an OCn unit.

28. The line connection changing device as claimed in claim 14, wherein the control command comprises a TL1 command composed of a storing slot number to the hardware portion of each unit, a port number on a network side of each unit and a channel number on each switch fabric side of each unit.
